(19) United States
(12) Patent Application Publication
(10) Pub. No.: US 2011/0019202 A1
(43) Pub. Date: Jan. 27, 2011

(54) Fabry-perot interferometer and manufacturing method of the same

(75) Inventors: Takao Iwaki, Nishikamo-gun (JP); Hiroyuki Wado, Toyota-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/805,225

(22) Filed: Jul. 20, 2010

(30) Foreign Application Priority Data
Jul. 21, 2009 (JP) 2009-170310

(51) Int. Cl. G01B 9/02

(52) U.S. Cl. 356/519; 216/24

(57) ABSTRACT

A Fabry-Perot interferometer and a manufacturing method of the same are disclosed. The Fabry-Perot interferometer includes a first mirror structure and a second mirror structure opposed to each other with a gap therebetween. A first mirror and a first electrode of the first mirror structure are electrically insulated from each other, or, a second mirror and a second electrode of the second mirror structure are electrically insulated from each other. In a state of voltage application between the first and second electrode, a distance “dmi” between the first mirror and the second mirror is shorter than a distance “dei” between a first-electrode-inclusive-portion and a second-electrode-inclusive-portion.

### CROSS REFERENCE TO RELATED APPLICATION

The present application is based on Japanese Patent Application No. 2009-170310 filed on Jul. 21, 2009, disclosure of which is incorporated herein by reference.

### BACKGROUND OF THE INVENTION

1. Field of the Invention

The present invention relates to a Fabry-Perot interferometer including a first mirror structure and a second mirror structure arranged opposed to each other with a gap therebetween. The present invention also relates to a manufacturing method of such Fabry-Perot interferometer.

2. Description of Related Art

For reduction of size of a Fabry-Perot interferometer, the use of MEMS (micro electro mechanical systems) technology to configure a Fabry-Perot interferometer has been proposed in, for example, Patent Documents 1 and 2.

A Fabry-Perot interferometer described in Patent Document 1 includes a pair of mirror structures arranged opposed to each other with an air gap therebetween. In each mirror structure, a silicon dioxide layer (i.e., a small refractive index layer) is provided between polycrystalline silicon layers (i.e., a large refractive index layer). A portion in which the silicon dioxide layer is interposed between the polycrystalline silicon layers acts as a mirror having an optical multilayered film structure. An electrode is formed in the polycrystalline silicon layer of each mirror structure by being doped with impurities.

A Fabry-Perot interferometer described in Patent Document 2 includes a pair of mirror structures arranged opposed to each other with an air gap therebetween. In each mirror structure, a small refractive index layer such as an air layer and the like is provided in part between large refractive index layers made of polycrystalline silicon or the like. In order to ensure a mechanical strength, the large refractive index layers in each mirror structure are in part in direct contact with each other to form a reinforcement part. By the reinforcement part, the mirror structure is segmentalized into multiple mirror parts each having the optical multilayered film structure, in which the air layer is interposed between the large refractive index layers. Moreover, in each mirror structure, a wiring part acting as an electrode is formed in the large-refractive index layer so that the wiring part is located in a periphery of the mirror part. In the above, the wiring part is a diffused layer doped with impurities.

Patent Document 1: JP-3457373B corresponding to U.S. Pat. No. 5,646,729B

Patent Document 2: JP-2008-134388A corresponding to US/20080123100A

The inventors of the present application have found that a conventional Fabry-Perot interferometer involves a difficulty. As a related art, discussion will be given below in connection with the difficulty.

In the Fabry-Perot interferometer described in Patent Documents 1, 2, a voltage is applied to the electrodes of the mirror structures to generate an electrostatic force. The electrostatic force displaces one mirror structure arranged above the air gap, thereby changing size of the air gap to selectively transmit the light with wavelengths determined by an inter-mirror distance “dm” between the opposed mirrors.

The wavelength of transmitted light is given as

λ=2×dm/n, Relation (1)

where n is an integer indicating an interferometer order number. As shown by Relation (1), in the case of the primary light (n=1), the wavelength λ of transmitted light is two times as large as the inter-mirror distance “dm” between the opposed mirrors.

According to the above Fabry-Perot interferometer, the electrostatic force is generated based on the voltage application to respective electrodes of mirror structures. The electrostatic force displaces a structure (i.e., the mirror structure), and changes the size of the gap. Here, a distance in the gap between the opposed electrodes is called an inter-electrode distance “de”. The inter-electrode distance “de” in the state of no voltage application is defined as “dei”. In a structure like the above Fabry-Perot interferometer, a pull-in limit is given in a situation where the distance “de” is decreased by “⅓ dei”. In other words, the pull-in limit is given a situation where the distance “de” is “⅔ dei” (i.e., de=dei×⅔). More specifically, if a decrease in the distance “de” between the opposed electrodes exceeds “⅓ dei”, the electrostatic force exceeds an elastic restoring force and the pull-in phenomena takes places. For the pull-in phenomena, see JP-2004-226362A.

The Fabry-Perot interferometer such as described in Patent Documents 1 and 2 is constructed such that the polycrystalline silicon layer acting as the large refractive index layer is in part doped with impurities, and thereby the electrode is formed in the polycrystalline silicon layer. Thus, in each mirror structure, the same electric potential is provided throughout the large refractive index layer. In other words, a part of the large refractive index layer, which part is not doped with impurities and constitutes the mirror, is electrically connected with the electrode. In each mirror structure, the mirror and the electrode has the same electric potential. Because of this, the mirror part acts as if the mirror were also an electrode for generating the electrostatic force. When the inter-mirror distance “dm” between the opposed mirrors in the state of no voltage application is defined as “dmi”, the pull-in limit is described as a situation where the distance “dm” is decreased by “⅓×dmi”. In other words, the pull-in limit is a situation where the distance “dm” is equal to ⅔×dmi (i.e., dm=dmi×⅔). As can be seen from the above, the conventional Fabry-Perot interferometer allows control of the distance “dm” between the opposed mirrors of the mirror structures in only a range between “dmi×⅔” and dmi. As a result, the conventional Fabry-Perot interferometer allows control of the wavelength λ of transmitted light in only a range between “dmi× 4/3” and “2×dmi” (in the case of n=1).

### SUMMARY OF THE INVENTION

In view of the above and other difficulties, it is an objective of the present invention to provide a Fabry-Perot interferometer that can control an inter-mirror distance in a large range without reaching a pull-in limit, and that can feature a wide spectroscopy band. It is also an objective of the present invention to provide a manufacturing method of such a Fabry-Perot interferometer.

According to a first aspect of the present invention, a Fabry-Perot interferometer is provided that includes a first mirror structure and a second mirror structure arranged opposed to each other with a gap therebetween. The first mirror structure includes a first mirror and a first electrode. The second mirror structure includes a second mirror opposed to the first mirror via the gap and a second electrode opposed to the first electrode via the gap. The gap is changeable due to an electrostatic force that is generated based on voltage application between the first electrode and the second electrode. The gap has an inter-mirror distance “dm” between the first mirror and the second mirror. The first mirror and the second mirror selectively transmit light with wavelengths determined by the inter-mirror distance “dm”. The first mirror structure and the second mirror structure have at least one of: a first configuration in which the first mirror and the first electrode are electrically insulated and separated from each other; and a second configuration in which the second mirror and the second electrode are electrically insulated and separated from each other. The first mirror structure has a first-electrode-inclusive-portion that is electrically connected with the first electrode and that is inclusive of the first electrode. The second mirror structure has a second-electrode-inclusive-portion that is electrically connected with the second electrode and that is inclusive of the second electrode. The gap further has an inter-electrode-inclusive-portion-distance “de” between the first-electrode-inclusive-portion and the second-electrode-inclusive-portion. The first mirror structure and the second mirror structure are constructed so that the inter-electrode-inclusive-portion-distance “dei” is larger than the inter-mirror distance “dmi”, where the inter-mirror distance “dmi” and the inter-electrode-inclusive-portion-distance “dei” are respectively the inter-mirror distance “dm” and the inter-electrode-inclusive-portion-distance “de” in a state of an absence of the voltage application between the first electrode and the second electrode.

According the above Fabry-Perot interferometer, the first mirror and the first electrode are electrically insulated and separated from each other, and/or, the second mirror and the second electrode are electrically insulated and separated from each other. Thus, when the voltage is applied between the first electrode and the second electrode to change the gap, the first mirror and the first electrode does not have the same electric potential, and/or, the second mirror and the second electrode does not have the same electric potential. The electrostatic force is not generated between the first mirror and the second mirror substantially or at all. Therefore, a pull-in limit depends on not the inter-mirror distance “dm” but the inter-electrode-inclusive-portion-distance “de” between the first-electrode-inclusive-portion and the second-electrode-inclusive-portion. Since the inter-mirror distance “dmi” is larger than the inter-electrode-inclusive-portion-distance “dei” in the state of the absence of the voltage application (i.e., dei>dmi), the Fabry-Perot interferometer can change the inter-mirror distance “dm” by more than “dmi×⅓” from the state of the absence of the voltage application. The Fabry-Perot interferometer can control the inter-mirror distance “de” in a large range without reaching a pull-in limit, and can broaden a spectroscopy band as compared to a convention Fabry-Perot interferometer.

According to a second aspect of the present invention, a method of manufacturing a Fabry-Perot interferometer is provided. The method includes: forming a first electrode and at least a part of a first mirror on one surface of a substrate, wherein the first electrode and the first mirror are parts of a first mirror structure; forming a sacrifice layer on the first mirror structure; forming a recession region on a surface of the sacrifice layer by pattering the sacrifice layer, so that the recession region is located on an opposite side of the sacrifice layer from the first mirror structure, wherein the recession region corresponds to a region in which a second mirror is to be formed; forming a second electrode and at least a part of the second mirror on the surface, which has the recession region, of the sacrifice layer, wherein the second electrode and the second mirror are parts of a second mirror structure; and after forming the second mirror structure, forming a gap between the first mirror structure and the second mirror structure by etching the sacrifice layer.

According to the above method, it is possible to manufacture a Fabry-Perot interferometer in which the inter-electrode-inclusive-portion-distance “dei” is larger than the inter-mirror distance “dmi”.

According a third aspect of the present invention, a method of manufacturing a Fabry-Perot interferometer is provided. The method includes: forming a convex region on one surface of a substrate by pattering the substrate, wherein the convex region corresponds a region in which a first mirror is to be formed; forming a first electrode and at least a part of the first mirror on the one surface, which has the convex region, of the substrate, wherein the first electrode and the first mirror are parts of a first mirror structure; forming a sacrifice layer on the first mirror structure; planarizing a surface of the sacrifice layer, wherein the surface to be planarized is located on an opposite side of the sacrifice layer from the first mirror structure; forming a second electrode and at least a part of a second mirror on the planarized surface of the sacrifice layer, wherein the second electrode and the second mirror are parts of a second mirror structure; and after forming the second mirror structure, forming a gap between the first mirror structure and the second mirror structure by etching the sacrifice layer.

According to the above method, it is possible to manufacture a Fabry-Perot interferometer in which the inter-electrode-inclusive-portion-distance “dei” is larger than the inter-mirror distance “dmi”.

### BRIEF DESCRIPTION OF THE DRAWINGS

The above and other objects, features and advantages of the present invention will become more apparent from the following detailed description made with reference to the accompanying drawings. In the drawings:

FIG. 1A is a sectional view illustrating a schematic configuration of a Fabry-Perot interferometer of a first embodiment in an initial state where a voltage is not applied;

FIG. 1B is a sectional view illustrating a schematic configuration of the Fabry-Perot interferometer in a state where a second mirror structure is displaced by a maximum displacement Δdmax to reach a pull-in limit from the initial state illustrated in FIG. 1A;

FIG. 2 is a graph illustrating the maximum displacement Δdmax as a function of a ratio “dei/dmi”;

FIG. 3 is a plan view more specifically illustrating a structure of the Fabry-Perot interferometer of the first embodiment viewed in a direction from a second mirror structure to a first mirror structure;

FIG. 4 is a sectional view taken along line IV-IV in FIG. 3;

FIGS. 5 to 10 are sectional views each illustrating a step of Fabry-Perot interferometer manufacturing process;

FIG. 11 is a sectional view illustrating a modification example of the first embodiment;

FIG. 12 is a sectional view schematically illustrating a Fabry-Perot interferometer of a second embodiment;

FIG. 13 is a graph illustrating Relation (11) between “dei/dmi” and “λmin/λmax” according to a third embodiment;

FIG. 14 is a plan view schematically illustrating a Fabry-Perot interferometer of a fourth embodiment;

FIG. 15 is a sectional view schematically illustrating a Fabry-Perot interferometer of a fifth embodiment;

FIG. 16 is a plan view schematically illustrating a first mirror structure of the Fabry-Perot interferometer;

FIG. 17 is a sectional view schematically illustrating a Fabry-Perot interferometer of a sixth embodiment;

FIG. 18 is a sectional view schematically more specifically illustrating a structure of the Fabry-Perot interferometer illustrated in FIG. 17;

FIGS. 19 to 24 are sectional views each illustrating a step of Fabry-Perot interferometer manufacturing process;

FIG. 25 is a sectional view of a modification example of the fifth embodiment;

FIG. 26 is a sectional view of another modification example; and

FIG. 27 is a sectional view of yet another modification example.

### DETAILED DESCRIPTION OF THE EXEMPLARY EMBODIMENTS

The exemplary embodiments are described below with reference to the accompanying drawings.

### First Embodiment

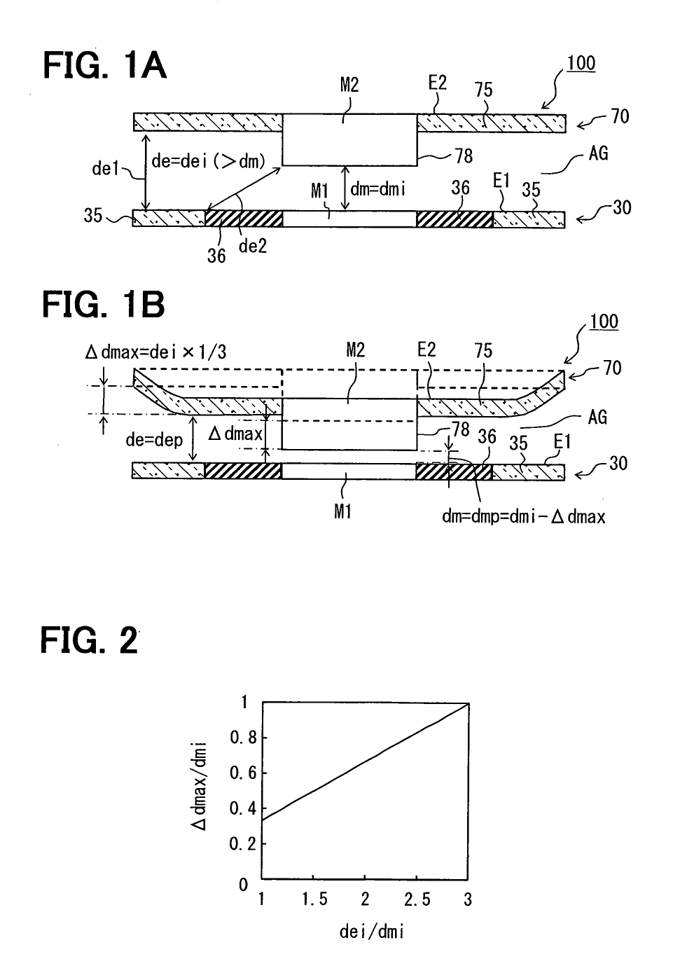

A first embodiment will be described. FIGS. 1A and 1B are sectional views each illustrating a schematic configuration of a Fabry-Perot interferometer 100 of the first embodiment. More specifically, FIG. 1A illustrates the Fabry-Perot interferometer 100 in an initial state where a voltage application between a first electrode M1 and a second electrode M2 is absent. FIG. 1B illustrates the Fabry-Perot interferometer in a state where a second mirror structure 70 is displaced to the pull-in limit from the initial state. The displacement of the second mirror structure 70 to the pull-in limit may be called herein the maximum displacement Δdmax. It should be noted in FIGS. 1A and 1B that although the second mirror M2 is illustrated thicker than the first mirror M2, this thickness difference does not define actual thicknesses of the first and second mirrors M1, M2. The thickness difference merely illustrates, for explanatory purpose, that the second mirror M2 is projected toward a first mirror structure 30 as compared to the second electrode 75, and that an inter-mirror distance “dmi” between the first and second mirrors M1, M2 in the initial state is shorter than an inter-electrode-inclusive portion distance “dei” between a portion E1 including the first electrode 35 and a portion E2 including'the second electrode 75 in the initial state (i.e., dmi<dei). Further, FIGS. 1A and 1B illustrates only parts of the first and second mirror structures 30, 70, which parts are opposed to each other via an air gap therebetween. FIG. 2 is a graph illustrating the maximum displacement Δdmax as a function of a ratio “dei/dmi” of the initial state inter-electrode-inclusive portion distance “dmi” to the initial state inter-mirror distance “dei”.

In the following, it is assumed, for illustrative purpose, that the gap between the first mirror structure 30 and the second mirror structure 70 is made of an air gap “AG”. Further, it is assumed that, of the two mirror structures 30, 70, only the second mirror structure 70 is displacable. A direction in which the second mirror structure 70 is displaced is referred to simply as a displacement direction. A direction perpendicular to the displacement direction is referred to as a perpendicular direction.

As shown in FIGS. 1A and 1B, the Fabry-Perot interferometer 100 of the present embodiment includes the first mirror structure 30 and the second mirror structure 70 arranged opposed to each other with the air gap AG therebetween. The first mirror structure 30 includes the first mirror M1 and the first electrode 35. The second mirror structure 70 includes a second mirror M2 opposed to the first mirror M1 via the air gap AG, and a second electrode 75 opposed to the first electrode 35 via the air gap AG. The first electrode 35 and the second electrode 75 have therein dopant impurities. The first mirror M1, the first electrode 35, the second electrode M2 and the second electrode 75 are included in the opposed parts via the air gap AG. The air gap AG has an inter-mirror distance “dm” between the first mirror M1 and the second mirror M2. The second mirror structure 70 is displaced by an electrostatic force that is generated based on the voltage applied between the first electrode 35 and the second electrode 75. The displacement of the second mirror structure 70 changes the air gap AG. The first and second mirrors. M1, M2 selectively transmit the light with wavelengths determined by the inter-mirror distance “dm”. In the Fabry-Perot interferometer 100, the first mirror structure 30 acts as what is called a fixed mirror, and the second mirror structure 70 acts as what is called a movable mirror, which is displacable due to the voltage application.

In the present embodiment, the first mirror structure 30 includes an insulating separation region 36 between the first mirror M1 and the first electrode 35. The insulating separation region 36 electrically separates and insulates the first mirror M1 and the first electrode 35 from each other. In contrast, the second mirror M2 and the second electrode 75 of the second mirror structure 70 are electrically connected with each other so that the second mirror M2 and the second electrode 75 have the same electric potential.

As described above, the Fabry-Perot interferometer 100 of the present embodiment is configured such that the first mirror M1 and the first electrode 35 of the first mirror structure 30 is electrically insulated and separated from each other. Thus, when the voltage is applied between the first electrode 35 and the second electrode 75 to change the air gap AG, the first mirror M1 and the first electrode 35 do not have the same electric potential. Because of this, an electrostatic force does not generate between the first mirror M1 and the second mirror M2 substantially or at all. The pull-in limit hence depends on the inter-electrode-inclusive portion distance “de” between a first-electrode-inclusive portion E1 and a second-electrode-inclusive portion E2. The first electrode-inclusive portion E1 is a portion of the first mirror structure 30 that is electrically connected with the first electrode 35 and that is inclusive of the first electrode 35. The second electrode-inclusive portion E2 is a portion of the second mirror structure 70 that is electrically connected with the second electrode 75 and that is inclusive of the second electrode 75. In the case of FIGS. 1A and 1B, the portion E1 includes only the first electrode 35, and the portion E2 includes the second electrode 75 and the second mirror M2.

The Fabry-Perot interferometer 100 has the initial state when the voltage application between the first and second electrodes 35, 75 is absent. As shown in FIG. 1A, the second mirror M2 of the second mirror structure 70 is projected into the air gap AG toward the first mirror structure 30 as compared to the second electrode 75. Thus, the second mirror structure 70 has a projection part 78 including the second mirror M2. The insulating separation region 36 of the first mirror structure 30 is arranged opposed to at lest a certain portion of the second mirror structure 70 except the projection part 78. In the case of FIGS. 1A and 1B, the insulating separation region 36 is opposed to the second electrode 75 via the air gap “AG”. More specifically, the portion E1 of the first mirror structure 30 is not directly opposed to the projection part 78 including the second mirror M2. The portion E1 is opposed to a certain part of (e.g., the second electrode 75, see FIGS. 1A and 1B) of the second mirror structure 70 other than the projection part 78. Because of the above structure, the initial state inter-electrode-inclusive portion distance “dei” between the first electrode-inclusive portion E1 and the second electrode-inclusive portion E2 is lager than the initial state inter-mirror distance “dmi” between the first mirror M1 and the second mirror M2 (i.e., dei>dmi).

Herein, the initial state inter-electrode-inclusive portion distance “dei” is defined as a minimum one among distances of the air gap “AG” between the first electrode-inclusive portion E1 and the second electrode-inclusive portion E2 in the initial state. In the present embodiment, since the insulating separation region 36 is provided not in the second mirror structure 70 having the projection part 78 but in the first mirror structure 30 as shown in FIG. 1A, a distance “de2” between the first electrode 35 (or the region E1) and the projection part 78 (or the second mirror M2) should be taken into consideration in addition to a distance “de1” between the first electrode 35 (or the region E1) and the second electrode 75.

In the present embodiment, the projection length of the projection part 78 (including the second mirror M2) from the second electrode 75 and a perpendicular direction width of the insulating separation region 36 are set, so that; in the initial state, the distance “de1” is the distance “dei”, which is minimum among distances between the portion E1 and the portion E2; and in the state of the voltage application (called also a displacement state), the distance “de1” is also minimum among distances between the portion E1 and the portion E2. When the distance “de1” between the first electrode (corresponding to the portion E1) and the second electrode 75 is made the distance “dei” in the above-described way, each of a direction of a change in the distance “de” and a direction of a change in the distance “dm” substantially matches the above-defined displacement direction. Thus, designing the Fabry-Perot interferometer 100 can be simplified compared to a case where the distance “dei” is the distance de2, which is a distance in a direction inclined with respect to the displacement direction.

When the Fabry-Perot interferometer 100 is changed from the initial state to the pull-in limit by changing the inter-electrode-inclusive distance “de” between the portion E1 and the portion E2 by Δdmax (=dmi×⅓), the inter-electrode-inclusive distance “de” becomes a distance “dep” given as

dep=dei×⅔ Relation (2)

In the above case, the inter-mirror distance “dm” between the first mirror M1 and the second mirror M2 becomes a distance “dmp” given as

dmp=dmi−(dei×⅓). Relation (3)

Since the Fabry-Perot interferometer 100 of the present embodiment satisfies the relation dei>dmi as is described above, the relation dei×⅓>dmi×⅓ is satisfied in the parenthesis of Relation (3). Thus, the second mirror structure 70 can be displaced by more than dmi×⅓ without reaching the pull-in limit, where “dmi” is a distance between the first mirror M1 and the second mirror M2 in the state of the absence of the voltage application. The Fabry-Perot interferometer 100 of the present embodiment can therefore broadens a spectroscopy band as compared to a conventional Fabry-Perot interferometer.

The above-described maximum displacement “Δdmax”, which is the displacement to the pull-in limit, can be described as

Δdmax/dmi=(dei/dmi)×⅓. Relation (4)

FIG. 2 is a graph illustrating Relation (4) between the maximum displacement “Δdmax” and the ratio “dei/dmi”. As is clear from FIG. 2B, when the relation “dei/dmi=3” is satisfied, the relation “Δdmax/dmi=1” is satisfied. In this case, it is possible to contact the first mirror M1 and the second mirror M2 each other without reaching the pull-in limit. It may be therefore preferable to set the distance “dei” between the portion E1 and the portion E2 to satisfy

dei≧3×dmi. Relation (5)

When Relation (5) is satisfied, it is possible to contact the first mirror M1 and the second mirror each other while preventing the pull-in phenomena from taking place. It is thus possible to further broaden a spectroscopy band. For the primary light (n=1), the wavelength of transmitted light is in a range between 0 and 2×dmi.

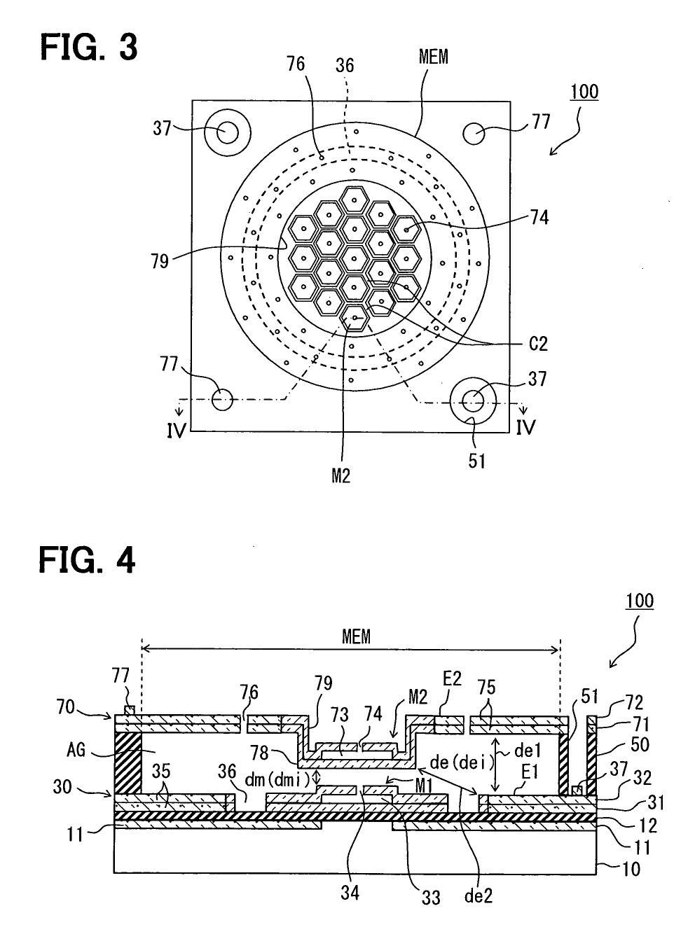

A structure of the above Fabry Perot interferometer 100 will be more specifically described. FIG. 3 is a plan view illustrating the structure of the Fabry-Perot interferometer 100 viewed in a direction from the second mirror structure 70 to the first mirror structure 30. In FIG. 3, for descriptive purpose, the insulating separation region 36 of the first mirror structure 30 is shown by dashed lines. FIG. 4 is a sectional view taken along line IV-IV in FIG. 3.

The below-described Fabry-Perot interferometer 100 has what is called an air mirror structure or an optical multilayer mirror. Some pats (e.g., mirror) of the Fabry-Perot interferometer 100 of the present embodiment can have the same structure as those of a Fabry-Perot interferometer described in JP-2008-134388A. Therefore, detailed explanation on some parts (e.g., the first mirrors M1, the second M2) may be omitted below. It should be noted that the assignee is the same between the present application and JP-2008-134388A.

As shown in FIG. 4, the Fabry-Perot interferometer 100 can employ, as a substrate 10, a planar rectangular semiconductor substrate made of single crystal silicon. The substrate 10 has an absorption part 11 at a surface layer of one surface thereof. The absorption part 11 is doped with impurities. Selectively in the perpendicular direction, the absorption part 11 is disposed in the surface layer except a region for spectroscopy. The region for spectroscopy is light transmissive for spectroscopy of the first mirror M1 and the second mirror M2. Due to the absorption part 11, the light transmission is suppressed except the spectroscopy region. An insulating film 12 is disposed on one planar surface of the substrate 10. The insulating film 12 has a substantially uniform thickness, and acts as an etching stopper when the insulating separation region 36 is formed. As the insulating film 12, a silicon nitride film 12 is used in the present embodiment. The first mirror structure 30 is disposed above the one surface of the substrate 10 through the insulating film 12.

The first mirror structure 30 is what is called a fixed mirror structure. The first mirror structure 30 includes a large refractive index lower layer 31 and a large refractive index upper layer 32. The large refractive index lower layer 31 is a semiconductor thin film that contains a material with a refractive index larger than an air. For example, the semiconductor thin film contains at least one of silicon and germanium. The large refractive index lower layer 31 is laminated above the whole one surface of the substrate 10 via the insulating film 12. The large refractive index upper layer 32 is made of a large refractive index material such as silicon and the like, as the large refractive index lower layer 31 is. The large refractive index upper layer 32 is laminated above the large refractive index lower layer 31. In one embodiment, both of the large refractive index upper and lower layers 31, 32 are made of polysilicon.

An air layer 33 is interposed between a part of the large refractive index lower layer 31 and a part of the large refractive index upper layer 32. The air layer 33 and the parts of the large refractive index layers 31, 32 are multilayered in the displacement direction, thereby forming an optical multilayered film structure, and acting as the first mirror M1. The first mirror M1 is constructed as an air mirror in which the air layer 33 is interposed. Moreover, the first mirror structure 30 includes a connection part C1 (not shown, cf. a connection part C2 in FIG. 3). The connection part C1 is a part where the large refractive index lower layer 31 and the large refractive index upper layer 32 are in contact with each other. The connection part C1 divides the first mirror structure 30 into multiple first mirrors M1, which are connected with each other via the connection part C1.

In the present embodiment, the first mirror structure 30 and the second mirror structure 70 match each other in layout of the mirror M1, M2 and the connection part C1, C2. In the above, the connection part C1 is a part where the large refractive index lower layer 31 and the large refractive index upper layer 32 are in contact with each other at a place between the adjacent first mirrors M1. In addition to the connection part C1, the large refractive index lower layer 31 and the large refractive index upper layer 32 are in contact with each other at a place different from a formation region of the first mirror M1.

The reference numeral 34 shown in FIG. 4 refers to an through hole 34, which is located at a part of the large refractive index layer 32 above the air layer 33. The through hole 34 is for forming the air layer 33 by etching via the through hole 34. In every segmentalized first mirror M1, the through hole 34 is provided.

The first mirror structure 30 has a planar rectangular shape so as to correspond in shape to the substrate 10. The first mirror structure 30 has a center region and a periphery region surrounding the center region. The above-described multiple first mirrors M1 are formed in the center region of the first mirror structure 30, like the below-described second mirrors M2. The first electrode 35 is formed in the periphery region. The first electrode 35 is formed by doping p or n conductive type impurities into at least the large refractive index upper layer 32, which is closer to the air gap “AG” as compared to the large refractive index lower layer 31. In one embodiment, the first electrode 35 having a p conductivity type is formed by implanting Boron (B) ions into the large refractive index layers 31, 32 made of polysilicon. A trench acting as the insulating separation region 36 is formed between the center region and the periphery region of the first mirror structure 30. The insulating separation region 36, the center region and the periphery region are arranged in the perpendicular direction.

The insulating separation region 36 penetrates through parts of the two large refractive index layers 31, 32 contacting with each other. As shown in FIG. 3 by dashed Fines, the insulating separation region 36 has a planar circular ring shape, and electrically and mechanically separates the center region, in which the first mirrors M1 and the connection part C1 are formed, and the periphery region, in which the first electrode 35 is formed. When the trench (e.g., void) is employed as the insulating separation region 36, since the first mirror structure 30 is a fixed mirror structure fixed to the electrode 10, it is unnecessary to take into consideration an displacement caused by an electrostatic force between the periphery region and the center region. In one embodiment, the first electrode 35 is a substantially whole region outward of the ring-shaped insulating separation region 36 in FIG. 3.

The insulating separation region 36 is arranged opposed to at least one of parts (e.g., the second electrode 75) of the second mirror structure 70 except the projection part 78 having the second mirror M2. Because of this arrangement and the projection part 78, in the initial state, the distance “dei” between the portion E1 and the portion E2 is larger than the distance “dmi” between the first mirror M1 and the second mirror M2. Moreover, a location and a width of the insulating separation region 36 in the perpendicular direction are arranged so that: the distance “de1” between the portion E1 and the second electrode 75 is smaller than the distance de2 between the portion E1 and the second mirror M2; and the distance de1 (which becomes “dei” in the initial state) between the region E1 and the second electrode 75 is minimum among the distances “de” between the portions E1 and E2.

In the example shown in FIG. 4, the large refractive index layers 31, 32 in the periphery region of the first mirror structure 30 has a ring shaped part that is adjacent to the insulating separation region 36 and is not doped with impurities. More specifically, the portion E1, which is electrically with the first electrode 35 and is inclusive of the first electrode 35, includes the first electrode 35 and the above ring-shaped and ion-undoped part in the large refractive index layers 31, 32. Alternatively, the whole periphery region located outward of the insulating separation region 36 may be the first electrode 35.

Herein, a membrane “MEM” is referred to as a part of the second mirror structure 70 located inward of a support 50. A pad 37 made of Au, Cr or the like is formed on the large refractive index upper layer 32 of the first mirror structure 30 so that the pad 37 is not opposed to the membrane “MEM” via the air gap “AG”. The pad 37 is in ohmic-contact with the first electrode 35, which is formed in the large refractive index layers 31, 32 as an impurity diffusion layer.

The support 50 is locally arranged on the large refractive index upper layer 32 of the first mirror structure 30 so that the support 50 is absent above a part opposed to the membrane “MEM”. The support 50 supports the second mirror structure 70 above the first mirror structure 30, and functions as a spacer for providing the air gap AG between the first mirror structure 30 and the second mirror structure 70. Thus, a thickness of the support 50 in the displacement direction is important in setting the distance “de1” and the like. In one embodiment, the support 50 contacts the electrodes 35, 75 and includes a silicon oxide film. The support 50 defines a hollow at a center thereof. The hollow of the support 50 corresponds in location to the membrane “MEM” of the second mirror structure 70. At a place outward of the membrane “MEM”, the support 50 has an opening 51 for forming and receiving the pad 37.

The second mirror structure 70 has what is called a movable mirror, and includes a large refractive index lower layer 71 and a large refractive index upper layer 72. The large refractive index lower layer 71 is a semiconductor thin film containing a material with a refractive index larger than an air. The semiconductor thin film, for example, contains at least one of silicon and germanium. The large refractive index lower layer 31 is disposed on a surface of the support 50, which bridges the air gap AG. Like the large refractive index lower layer 71, the large refractive index upper layer 72 is made of a large refractive index material such as silicon and the like. The large refractive index upper layer 72 is laminated above the large refractive index lower layer 71. In one embodiment, both of the large refractive index upper and lower layers 71, 72 are made of polysilicon.

An air layer 73 is interposed between a part of the large refractive index lower layer 71 and a part of the large refractive index upper layer 72. The air layer 73 and the parts of the large refractive index layers 71 and 72 are multilayered, thereby forming an optical multilayered film structure acting as the second mirror M2. Like the first mirror M1, the second mirror M2 is also constructed as an air mirror in which the air layer 73 is interposed. In the state of the absence of the voltage application between the electrodes 35 and 75, a surface of the large refractive index lower layer 71 exposed to the air gap AG is substantially parallel to a surface of the large refractive index upper layer 32 exposed to the air gap AG.

As shown in FIG. 3, the second mirror structure 70 includes the connection part C2. The connection part C2 divides the second mirror structure 70 into multiple second mirrors M2, which are connected with each other via the connection part C1. More specifically, the connection part C2 is located between the adjacent second mirrors M2, and is a part where the large refractive index lower layer 71 and the large refractive index upper layer 72 are in contact with each other. It should be noted that the large refractive index lower layer 71 and the large refractive index upper layer 72 are also in contact with each other at, in addition to the connection part C2, a region different in location from the formation region of the second mirrors M2.

The reference numeral 74 shown in FIGS. 3 and 4 refers to a through hole 74 located in a part of the large refractive index layer 72 above the air layer 73. The through hole 74 is for forming the air layer 73 by etching via the through hole 74. In each segmentalized second mirror M1, the through hole 34 is disposed.

The second mirror structure 70 has a center region and a periphery region surrounding the center region. Together with the connection part C2, the above-described multiple first mirrors M2 are formed in the center region of the second mirror structure 70. Note that the second mirror structure 70 has a planar rectangular shape so as to correspond in shape to the substrate 10. The second electrode 75 is formed in the periphery region of the second mirror structure 70. The second electrode 75 is formed by incorporating the p or n conductive type impurities into the large refractive index layers 71, 72. The second electrode 75 is in contact with ion-undoped parts of the large refractive index layers 71, 72. That is, the second electrode 75 is electrically and mechanically connected with the second mirror, M2. The whole of the second mirror structure 70 is the portion E2 having the same electric potential as the second electrode 75. The membrane “MEM” is the center region and a part of the periphery region of the second mirror structure 70. In the above, the part of the periphery region of the second mirror structure 70 is a part located inward of the support 50 bridging the air gap “AG”, in other words, a part located above the air gap “AG”.

As shown in FIG. 4, the projection part 78 having the second mirror M2 and the connection part C2 is projected into the air gap AG toward the first mirror structure 30. That is, the second mirror structure 70 includes the projection part 78. The second mirror M2 and the connection part C2 are formed in the projection part 78. The second electrode 75 is formed in a part different in location from the projection part 78, i.e., the second electrode 75 is formed in a periphery of the projection part 78. Because of the projection part 78 and the insulating separation region 36, the distance “dei” between the portions E1 and E2 is larger than the distance “dmi” between the first and second mirrors M1 and M2.

In the present embodiment in particular, the first and second mirror structures 30, 70 and the support 50 are arranged to satisfy Relation (4). It should be noted that the projection of the second mirror M2 may suffice if a part of the large refractive index lower layer 71 constituting the second mirror M2 is, as compared to the surface of the second electrode exposed to the air gap AG, located close to the surface of the second electrode 75 exposed to the air gap AG in the displacement direction.

In the present embodiment, as shown in FIG. 3, a surface of the second mirror structure 70 opposite to the projection part 78 has a recession region 79, which has a flat circular shape. On a bottom of the recession region 79, the second mirror M2 and the connection part C2 are located. Together with the insulating separation region 36, a projection length of the projection part 78 in the displacement direction and a size of the projection part 78 in the perpendicular direction are set to satisfy the following conditions: the distance “de” between the portion E1 and an outer surface of a corner part between a bottom and a side of the projection part 78 is not minimum among the distances “de” between the region E1 and the portion E2; and the distance “dei” between the portion E1 and the portion E2 has a predetermined relationship with the distance “dmi” between the first mirror M1 and the second mirror M2.

In the example shown in FIG. 4, the second electrode 75 of the second mirror structure 70 is located in the substantially whole periphery of the projection part 78. However, the formation region of the second electrode 75 is not limited to this example. Because the incorporation of impurities decreases optical transparency, the second electrode 75 may be formed in any region the second mirror structure 70 other than the second mirror M2.

The reference numeral 76 shown in FIGS. 3 and 4 refers to a through hole 76 that is formed on the membrane “MEM” at a place except the formation region of the second mirror M2. The through hole 76 is for forming the air gap AG, the air layer 33 and the insulating separation region 36 by etching through the through hole 76. The reference numeral 77 shown in FIGS. 3 and 4 refers to a pad 77 that is formed on the second electrode 75 (i.e., the large refractive index layer 72) and is located outward of the membrane “MEM”. The pad 77 is made of Au, Cr or the like.

When the polysilicon is used for the large refractive index layers 31, 32, 71, 72 of the mirror structures 30, 70, the Fabry-Perot interferometer 100 can be preferably used as a wavelength selection filter of an infrared gas sensor because the polysilicon is transmissive for infrared light with wavelengths between about 2 μm to 10 μm. The above advantage can be also provided when a semiconductor thin film containing at least one of silicon and germanium, e.g., poly germanium or poly silicon-germanium, is used for the large refractive index layers 31, 32, 71, 72.

Moreover, when the air layers 33, 73 are employed as the small refractive index layers of the mirrors M1, M2, it is possible to provide at low cost the Fabry-Perot interferometer 100 that can enlarge a ratio nH/nL (e.g., 3.3 or more) of a refractive index nH (e.g., 3.45 in Si, 4 in Ge) of the large refractive index layer to a refractive index nH of the small refractive index layer nL (1 in air), and that can selectively transmit the infrared light with wavelengths between about 2 μm to 10 μm.

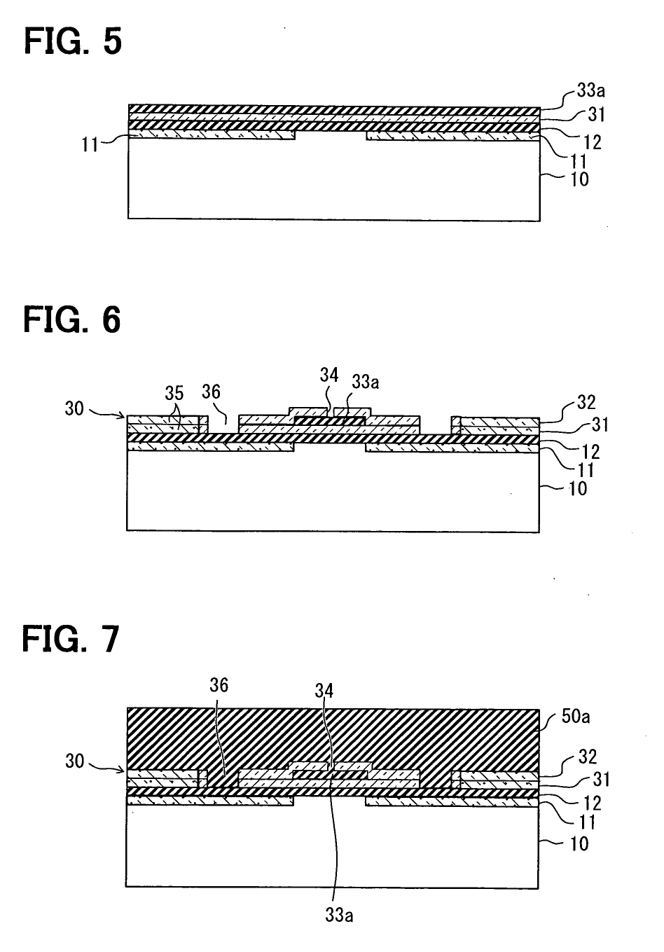

An example of a manufacturing method of the above Fabry-Perot interferometer 100 will be described below. FIGS. 5 to 10 are sectional view illustrating a manufacturing method of the Fabry-Perot interferometer 100 illustrated in FIG. 4. Steps of the manufacturing method may be successive in the order from the FIG. 5.

First, as shown in FIG. 5, a semiconductor substrate made of single crystal silicon is prepared as the substrate 10. By incorporating impurities such as boron (B) and the like, an absorption part 11 is formed in a surface layer of one surface of the substrate 10 except a region for spectroscopy of the first mirror M1 and the second mirror M2. Then, an insulating film 12 such as a silicon nitride film and the like is deposited and uniformly formed on the whole one surface, which may be planar, of the substrate 10. The insulating film 12 acts as an etching stopper in formation of the trench acting as the insulating separation region 36. A large refractive index lower layer 31 and a small refractive index layer 33a are deposited and formed on the insulating film 12 in this order. In the above, the large refractive index lower layer 31 may be a polysilicon film or the like, and the small refractive index layer 33a may be a silicon oxide film or the like. A mask (not shown) including a resist or the like is formed on a surface of the small refractive index layer 33a. Etching the small refractive index layer 33a through the mask is conducted by, for example, anisotropic dry etching such as RIE (reactive-ion etching) and the like, thereby patterning the small refractive index layer 33a, as shown in FIG. 6. The patterned small refractive index layer 33a will be etched at a later process in order to form an air layer 33 of the first mirror M1. Then, the mask is removed, and a large refractive index layer upper 32 made of polysilicon or the like is formed above the large refractive index lower layer 31 so as to cover the small refractive index layer 33a.

Then, a mask (not shown) is formed on a surface of the large refractive index upper layer 32. Through the mask, the large refractive index layers 31, 32 are etched by, for example, anisotropic dry etching such as RIE and the like, and a trench acting as an insulating separation region 36 is formed at a predetermined position, so that the trench penetrates through the large refractive index layers 31 and 32. Further, a through hole 34 reaching the small refractive index layer 33a is formed at a part of the large refractive index layer 32 above the small refractive index layer 33a. Then, after the mask is removed, another mask is newly formed on a surface of the large refractive index upper layer 32. Through the mask, impurities are implanted into the large refractive index layers 31, 32 by ion implantation. In this ion implantation, the impurities are selectively implanted into only a periphery region outward of the insulating separation region 36 because the impurities in the formation region of the first mirror M1 causes the light absorption. By the ion implantation, a first electrode 35 is formed.

Alternatively, the first mirror structure 30 may be formed in such manner that, after the first electrode 35 is formed, the large refractive index layers 31, 32 may be etched to form the trench acting as the insulating separation region 36.

Then, as shown in FIG. 7, the mask is removed, and a sacrifice layer 50a such as a silicon oxide film and the like is deposited and formed on the whole of a surface of the large refractive index upper layer 32. In the above, the sacrifice layer 50a is deposited in the through hole 34 and the trench acting as the insulating separation region 36. A material of the sacrifice layer 50a is not limited to a particular material as long as the sacrifice layer 50a is made of an electrically-insulating material. It may be however preferable that a material of the sacrifice layer 50a and that of the small refractive index layer 33a be the same. The sacrifice layer 50a after formation of the air gap AG will mainly be a support 50. Thus, the sacrifice layer 50a is made have a film thickness equal to the distance between the first and second mirror structures 30, 70 in the initial state of the absence of the voltage application.

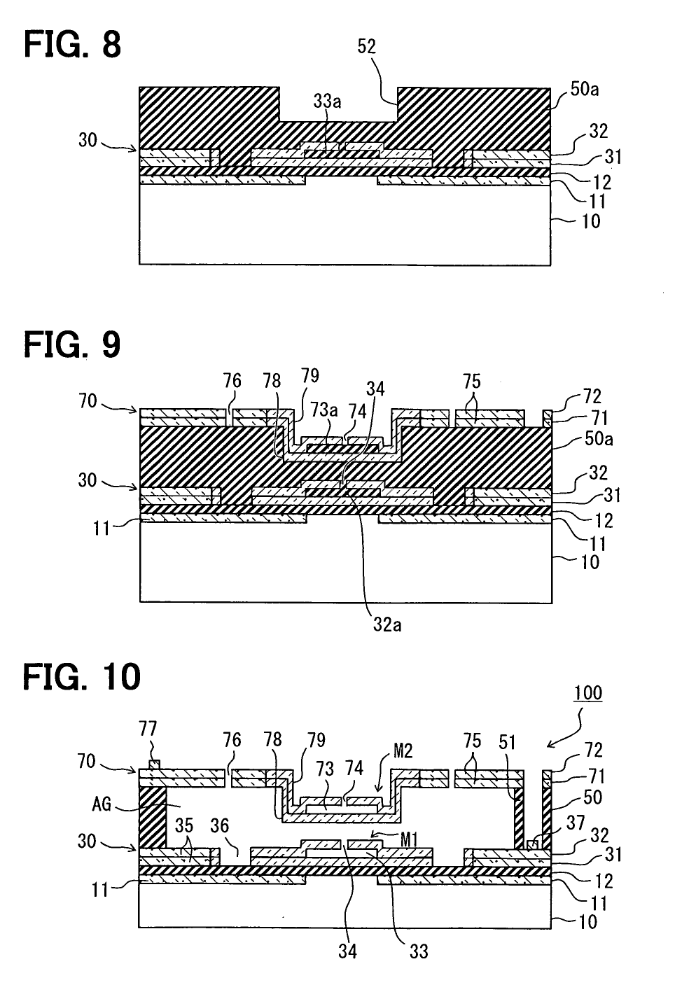

The Fabry-Perot interferometer 100 is, as described above, constructed so that the inter-mirror distance “dmi” between the mirrors is different from the inter-electrode-inclusive-portion distance “dei” (del) between the electrodes in the initial state, and the relation “dei>dmi” is satisfied. That is, as compared to the second electrode 75, the second mirror M2 of the second mirror structure 70 is projected toward the first mirror structure 30. In this relation, as shown in FIG. 8, a mask (not shown) is formed on a surface of the sacrifice layer 50a so that the mask is located on an opposite side of the sacrifice layer 50a from the first mirror structure 30. Through the mask, the sacrifice layer 50a is etched by, for example, anisotropic dry etching such as RIE and the like. Thereby, a recession region 52 is formed at a place corresponding to the location of the center region where the second mirror M2 is to be formed. In other words, the recession region 52 is formed at a region corresponding to the location of the projection part 78 of the second mirror structure 70.

After the recession region 52 is formed, a large refractive index layer 71 made of polysilicon or the like is deposited and formed on the whole surface of the sacrifice layer 50a including the recession region 52, as shown in FIG. 9. Then, a small refractive index layer 73a such as a silicon oxide film and the like is deposited and formed. Then, a mask (not shown), which may include a resist or the like, is formed on a surface of the small refractive index layer 73a. Through the mask, the small refractive index layer 73a is etched, so that a portion of the small refractive index layer 73a for the second mirror M2 selectively remains. More specifically, the small refractive index layer 73 is patented so that the second mirror M2 is formed above a bottom of the recession region 52 as described above. Then, after the mask is removed, a large refractive index upper layer 72 is deposited and formed above the large refractive index lower layer 71 so as to cover the patented small refractive index layer 73a. Thereby, a projection part 78 of the second mirror structure 70 is formed.

Then, another mask is newly formed on a surface of the large refractive index upper layer 72. Through the mask, impurities are implanted into the large refractive index layers 71, 72 by ion implantation. In this ion implantation, impurities are selectively implanted into parts of the second mirror structure 70 other than the projection part 78; in other words, impurities are selectively implanted into only parts of the large refractive index layers 71, 72 above a periphery of the recession region 52 of the sacrifice layer 50a. By the ion implantation, the second electrode 75 is formed, so that the second electrode 75 is located more spaced apart from the first mirror structure 30 in the displacement direction as compared to the second mirror M2.

After the ion-implantation, a rear surface of the substrate 10 opposite to the one surface (i.e., front surface) may be grinded and polished on an as-needed basis. After the mask is removed, a mask is newly formed on a surface of the large refractive index upper layer 72, and the large refractive index layers 71, 72 are selectively removed by etching. Thereby, a through hole 76 penetrating through the large refractive index layers 71, 72 is formed. Further, a through hole 74 reaching the small refractive index layer 73a is formed at a part of the large refractive index upper layer 72 above the small refractive index layer 73a.

Then, a part, at which the air gap AG is to be formed, of the sacrifice layer 50a is etched through the through hole 76 to form an air gap AG. In the above etching, the sacrifice layer 50a filling the insulating separation region 36 is also removed with the insulating film 12 acting as the etching stopper, and the insulating separation region 36 is made a trench (i.e., void) communicating with the air gap AG. Further, through the through holes 34 and 74, the small refractive index layers 33a and 73a are etched, and the air layer 33, 73 are formed. In the present embodiment, the above etching processes are performed at the same step by gas-phase or vapor-phase etching using hydrofluoric acid. By this etching, the air gap AG and the support 50 are formed, and the air layers 33, 73 and the mirrors M1, M2 are formed. Then, through forming the opening 51 and the pads 37, 77, the Fabry-Perot interferometer 100 illustrated in FIG. 4 is manufactured.

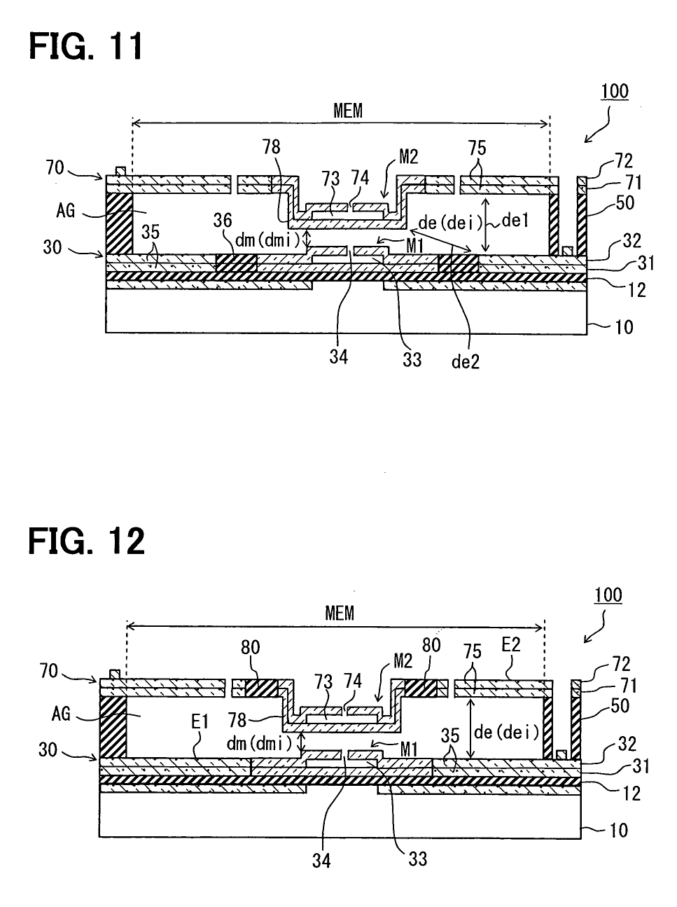

In the above example, the trench (i.e., void) electrically and mechanically separating the first mirror M1 from the first electrode 35 is employed as an example of the insulating separation region 36. However, the insulating separation region 36 for electrically and mechanically separating the first mirror M1 from the first electrode 35 is not limited to the above example. For example, as shown in FIG. 11, the insulating separation region 36 may be an impurities-diffused region with an n conductivity type. In this case, although the first mirror M1 and the first electrode 35 are electrically separated from each other, the first mirror M1 and the first electrode 35 are constructed to be mechanically coupled with each other. Alternatively, the insulating separation region 36 may be a′ trench with which an electric insulating material is filled. FIG. 11 illustrates the above described medication example so as to corresponds to FIG. 4.

### Second Embodiment

A Fabry-Perot interferometer 100 of a second embodiment will be described. FIG. 12 is a sectional view illustrating a schematic configuration of the Fabry-Perot interferometer 100 of the second embodiment. FIG. 12 corresponds to FIG. 4.

A structure difference between the first embodiment and the second embodiment includes the following. In the Fabry-Perot interferometers 100 of the second embodiment, the large refractive index layers 31, 32 of the first mirror M1 are electrically connected with the first electrode 35, and the large refractive index layers 71, 72 of the second mirror M2 are electrically insulated and separated from the second electrode 75. Other structures may be the same between the first and second embodiments.

As shown in FIG. 12, the first mirror structure 30 is constructed as follows. The first electrode 35 is further disposed at a place where the insulating separation region 36 is formed in the first embodiment. The center region having the first mirror M1 with no impurities doped and the periphery region having the first electrode 35 are adjacent and in contact with each other. Thus, the center region and the periphery region are included in the first electrode inclusive portion E1, which is a portion electrically connected with and inclusive of the first electrode 35. In the above, the center region

The second mirror structure 70 is constructed as follows. An insulating separation region 80 is formed between (i) the center region having the projection part 78 with the second mirror M2 and (ii) the periphery region with the second electrode 75. The insulating separation region 80 is a part of the membrane “MEM”. The insulating separation region 80 functions to electrically insulate and separate the second mirror M2 from the second electrode 75, and mechanically connect the second mirror M2 and the second electrode 75. To do so, for example, when the second electrode 75 has a p conductivity type, an impurities diffused layer with an n conductivity type may be used as the insulating separation region 80. The insulating separation region 80 is formed in the second mirror structure except the projection part 78 or formed in the projection part 78 except the second mirror M2 and the connection part C2, so that the second mirror M2 is located in the projection part 78 and the second electrode 75 is located in parts of the second mirror structure 70 other than the projection part 78. In the example shown in FIG. 12, the insulating separation region 80 is located outside the projection part 78.

The second mirror structure 70 is constructed so that the second mirror M2 is more projected than the second electrode 75, and the insulating separation region 80 electrically separates the second mirror M2 and the second electrode 75 from each other. In this structure, since the large refractive index layers 71, 72 of the projection part 78 is electrically separated from the second electrode 75, it is not necessary to take into consideration the distance “de” between the projection part 78 and the portion E1 like the case of the first embodiment. It is therefore possible to facilitate designing the Fabry-Perot interferometer 100. Further, since it is not necessary to take into consideration the distance “de”, it is possible to reduce width of the insulating separation region 80 in the perpendicular direction as compared to width of the insulating separation region 36. It is thus possible to reduce size of the Fabry-Perot interferometer 100.

### Third Embodiment

A Fabry-Perot interferometer 100 of a third embodiment will be described. The Fabry-Perot interferometer 100 of the third embodiment and that of the first embodiment can be the substantially same in a basic structure. A different from the first embodiment includes the following. The Fabry-Perot interferometer 100 of the third embodiment is constructed to satisfy, in stead of Relation (5), the following relation:

dei≧3×(1−λmin/λmax)×dmi Relation (6)

where “λmin” and “λmax” are respectively a minimum wavelength and a maximum wavelength of a wavelength range of transmitted light. Explanation will be given below on Relation (6). In the initial state of no voltage application, the inter-mirror distance “dm” between the first mirror M1 and the second mirror M2 has the largest value “dmi”, and the wavelength of the transmitted light is maximum “λmax”. The distance “dmi” and the wavelength “λmax” satisfy

dmi=λmax×½. Relation (7)

When the second mirror structured is displaced by the maximum displacement Δdmax to reach the pull-in limit, the wavelength of transmitted light is λmin. The distance “dmi”, the maximum displacement “Δdmax” and the wavelength “λmin” satisfy the following relation:

dmi−Δdmax=λmin×½. Relation (8)

A sufficient condition for the wavelength range of transmitted light to contain λmin is given as:

dmi−Δdmax≦λmin×½. Relation (9)

The division of Relation (9) by Relation (7) gives

1−Δdmax/dmi≦λmin/λmax. Relation (10)

By using the distances “dmi” and “dei”, the maximum displacement Δdmax can be written as:

Δdmax/dmi=dei/dmi×⅓ Relation (11)

From Relations (10) and (11), Relation (6) can be derived. Note that Relation (6) is a structure requirement to set a wavelength range of selectively-transmitted light between λmin and λmax.

In the above-described way, a structure and an arrangement of the first and second mirror structures 30 and 70 of the present embodiment are determined to satisfy Relation (6). It is hence possible to transmit light in a range between λmin and λmax.

Making the left side equal to the right side in Relation (6) leads to:

dei/dmi=3×(1−λmin/λmax). Relation (12)

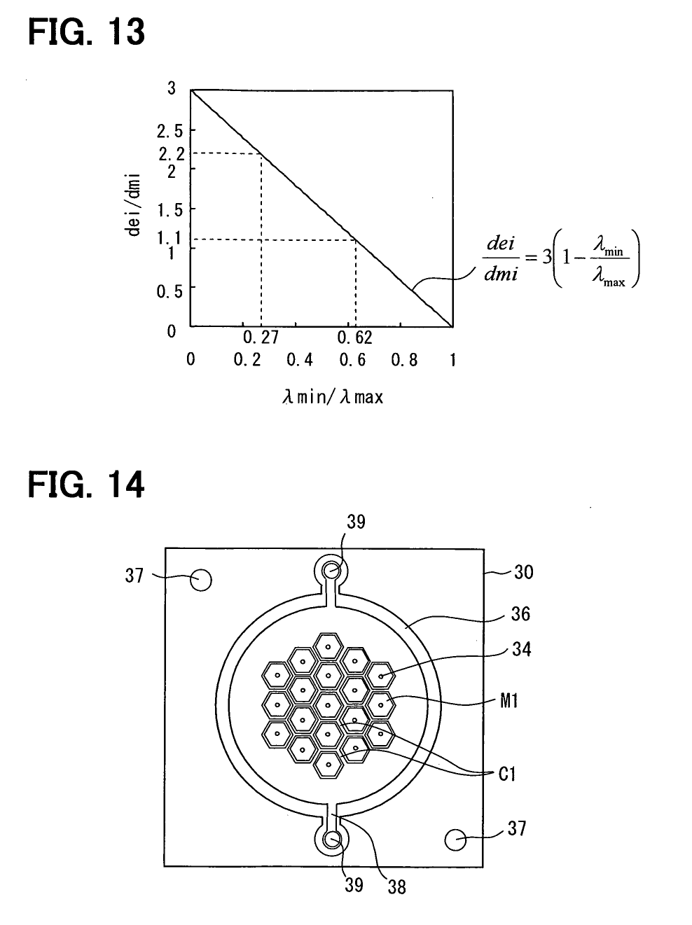

Relation (12) is illustrated in FIG. 13. Exemplary gases have the following infrared absorption wavelengths: 4.2 μm for CO2, 3.4 μm for ethanol and 2.6 μm for water vapor.

The ratio λmin/λmax can be set to 0.62 (=2.6/4.2) in order for the one Fabry-Perot interferometer 100 to detect CO2, ethanol and water vapor with a primary light (n=1). Therefore, when the Fabry Perot interferometer 100 is configured to satisfy

dei≦1.1×dmi, Relation (13)

this Fabry Perot interferometer 100 can detect CO2, ethanol and water vapor using a primary light (n=1), and can be preferably used for an alcometer (e.g., alcohol breath test sensor).

The ethanol has another infrared absorption wavelength of 9.5 μm.

When the wavelength λmax is set to 9.5 μm, the ratio λmin/λmax is 0/27 (≈2.6/9/5). Thus, the above Fabry-Perot interferometer may be configured to satisfy

dei≧2.2dmi. Relation (14)

This Fabry-Perot interferometer can further detect an ethanol absorption wavelength of 9.5 μm. It is possible to more precisely detect CO2, ethanol and water vapor using a primary light (n=1).

The present embodiment can be applied to or combined with the modification example of the first embodiment or the second embodiment.

### Fourth Embodiment

A Fabry-Perot interferometer 100 of a fourth embodiment will be described below. FIG. 14 is a plan view illustrating a schematic configuration of a first mirror structure of a Fabry-Perot interferometer of the fourth embodiment.

The Fabry-Perot interferometer 100 of the fourth embodiment and that of the first embodiment are the substantially same in a basic structure. A different from the first embodiment includes the following. In the fourth embodiment, the large refractive index layers 31, 32 of the first mirror M1, which is electrically insulated from the first electrode 35, has the same electric potential as the second electrode 75 (i.e., the portion E2) of the second mirror structure 70.

The above difference will be described with reference to one example structure. In the Fabry-Perot interferometer 100, the large refractive index layers 31, 32 of the first mirror M1 is electrically coupled with the second electrode 75 or the second portion E2 of the second electrode structure 70 via an electric connection member such as a wiring and the like. According to this structure, the first mirror M1 and the second electrode 75 (i.e., portion E2) has the same electric potential.

In another aspect of the above difference, the Fabry-Perot interferometer 100 can employ the following method as a method of driving the membrane “MEM”. The air gap “AG” is changed by the electrostatic force generated based on the voltage applied between the electrodes 35 and 75 while the mirror (e.g., the first mirror M1) electrically insulated the electrode (e.g., the first electrode 35) of one mirror structure (e.g., the first mirror structure 30) is being made have the same electric potential as the electrode and the mirror (e.g., the second electrode 75 and the second mirror M2) of the other mirror structure (e.g., the second mirror structure 70).

To realize the above configuration, the first mirror structure 30 can be constructed as follows. As shown in FIG. 14, the first mirror structure 30 includes an extension part 38 connected to the planar circular center region, in which the first mirror M1 and the connection part C1 is formed. The extension part 38 extends into a portion corresponding to the periphery portion of the first embodiment. In the extension part 38, the large refractive index layers 31, 32 are in contact with each other. A pad 39 made of Au, Cr or the like is formed on a surface of an end part of the extension part 38. An impurities diffused layer acting as a wiring (not shown) is formed in the extension part 38. The wiring has an ohmic contact with the center region, in which the first mirror M1 and the connection part C1 are formed. Because impurities absorb light, the impurities-based wiring is formed at parts other than the first mirror M1. In the present embodiment, two extension parts 38 are formed on opposite sides of the center region.

A trench (void) acting as the insulating separation region 36 surrounds the center region and the extension part 38. Although not shown in the drawings, the pad 39 is exposed to an outside through an opening (not shown) of the support 50 in a manner similar to the relationship between the pad 37 and the opening 51 of the support 50. A wiring or the like is connectable to the pad 39.

In the present embodiment, because of the above structure, the first mirror M1 is electrically separated from the first electrode 35. The second mirror M2 is electrically connected with the second electrode 75. The first mirror M1 and the second electrode 75 have the same electric potential. Therefore, when the voltage is applied between the first electrode 35 and the second electrode 75 to drive and displace the membrane “MEM” of the second mirror structure 70, the first mirror M1 has the same electric potential as the second electrode 75 and consequently has the same potential as the second mirror M2. As a result, an electrostatic force is not generated between the first mirror M1 and the second mirror M2. Thus, it is possible to further broaden a spectroscopic band as compared to a structure where the first mirror M1 has a floating electric potential (cf. first embodiment). Moreover, the absence of the electrostatic force between the first mirror M1 and the second mirror M2 advantageously enables easy control and adjustment of the air gap AG to a desired clearance.

The present embodiment can be applied to or combined with the modification example of the first embodiment, the second embodiment, or the third embodiment.

### Fifth Embodiment

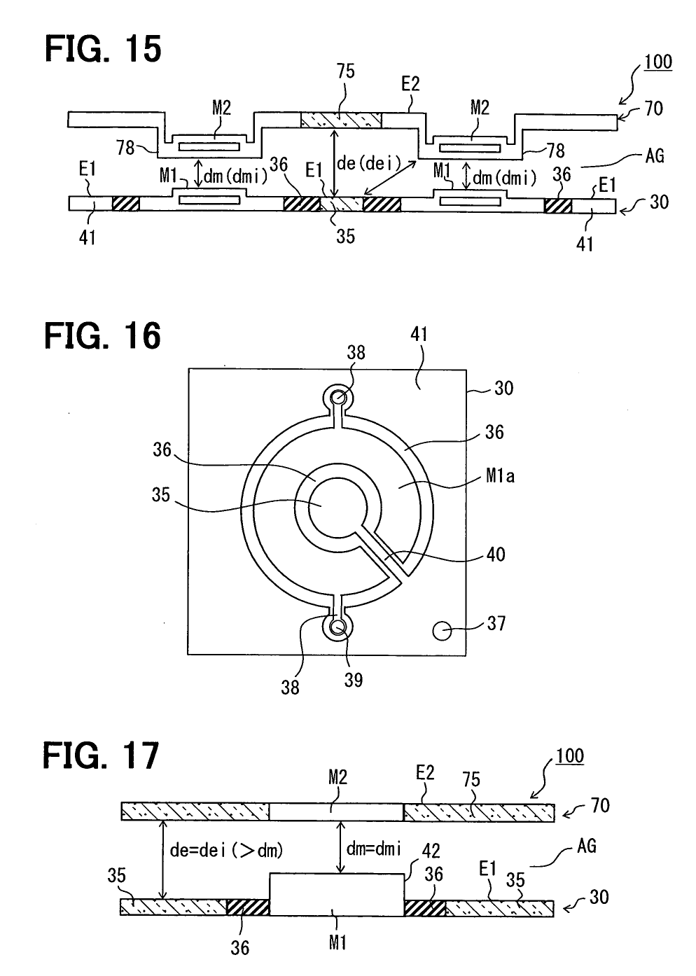

A Fabry-Perot interferometer 100 of a fifth embodiment will be described below. FIG. 15 is a sectional view illustrating a schematic configuration of the Fabry-Perot interferometer 100 of the fifth embodiment. FIG. 16 is a plan view illustrating a schematic configuration of the first mirror structure 30 of the Fabry-Perot interferometer 100.

The Fabry-Perot interferometer 100 of the fifth embodiment and that of the first embodiment can be the substantially same in a basic structure. A difference from the first embodiment includes the following. As shown in FIGS. 15 and 16, in each mirror structure 30, 70, at least a part of the electrode 35, 75 is formed in the center region. The mirror M1, M2 is formed in the periphery region surrounding the center region.

FIG. 16 illustrates the first mirror structure 30. The reference symbol “M1a in FIG. 16 refers to a first mirror formation region M1a having the first mirror M1 and the connection part C1. The first mirror formation region M1a and the center region of the first embodiment have the basically same structure. Note that the center region of the first embodiment is the formation region of the first mirror M1.

As shown in FIG. 16, the first mirror structure 30 with the planar rectangular shape has the center region with a planar circular shape and the periphery region surrounding the center region. In the center region, a part of the first electrode 35 is provided. In the periphery region, the first mirror M1 is provided. The first mirror structure 30 further include a connection part 40, via which the center region or the first electrode 35 is connected with an outermost part 41 located outward of the first mirror formation region M1a. A pad 37 for the first electrode 35 is disposed on a surface of the large refractive index layer 32 of the outermost part 41. The first mirror formation region M1a has a substantially planer “C” shape. The connection part 40 is disposed between ends of the “C” shape. In the connection part 40 and the outermost part 41, the large refractive index layers 31, 32 are in contact with each other, and have implanted impurities like the first electrode 35 of the center region has. That is, the center region, the connection part 40 and the outermost part 41 act as the first electrode 35.

Moreover, the first mirror formation region M1a is connected with the extension part 38 in a manner similar to the fourth embodiment. The extension part 38 extends into a part that corresponds to the periphery region of the first embodiment. A pad 39 made of Au, Cr or the like is formed on a surface of an end part of the large refractive index upper layer 32 constituting the extension part 38. The Fabry-Perot interferometer 100 is constructed so that the first mirror M1 can have the same electric potential as the second electrode 75 of the second mirror structure 70; hence, the first mirror M1 can have the same electric potential as the second mirror M2.

The trench (void) acting as the insulating separation region 36 electrically mechanically insulates and separates the center region, the connection part 40 and the outermost part 41, each of which acts as the first electrode 35, from the first mirror formation region M1a and the extension part 38. Because of this, the first mirror M1 and the first electrode 35 are electrically insulated and separated from each other.

The second mirror structure 70 is constructed as follows. At least a part of the second electrode 75 is formed in the center region of the second mirror structure 70. The second mirror M2 is formed in the periphery region surrounding the center region. More specifically, the second mirror M2 is formed in a second mirror formation region (not shown) with a substantially planar “C” shape so as to correspond in shape to the first mirror M1. In a manner similar to the connection part 40, the second electrode 75 is electrically coupled with a corresponding pad 77 via a connection part (not shown). In one embodiment, two connection pars are provided on opposite sides of the second mirror formation region.

According to the above Fabry-Perot interferometer 100, a part of the first electrode 35 and a part of the second electrode 75 are respectively formed in the center regions, which is located at a larger distance from the support 50 than a distance from the support 50 to the periphery region. In other words, the second electrode 75 is formed at a center of the membrane “MEM”. In the above, the center is an easily flexible part among the membrane “MEM”. Accordingly, a spring constant of the membrane “MEM” of the second mirror structure 70 is smaller compared to the first embodiment. It is therefore possible to reduce the applied voltage for adjusting the air gap “AG” to a desired clearance, compared to the applied voltage in the first embodiment.

As described in the first embodiment, when the mirror M1, M2 is formed in the center region located distant from the support 50, it is easy to keep the first and second mirrors M1, M2 parallel to each other even in the state of the voltage application. Therefore, compared to the present embodiment, it is possible to reduce full width at half maximum (FWHM) of transmitted light wavelength while reducing the size of the Fabry-Perot interferometer 100.

A method of manufacturing the Fabry-Perot interferometer 100 of the present embodiment can be the substantially same as that illustrated in the first embodiment.

The present embodiment can be applied to and combined with the modification example of the first embodiment, the second embodiment, or the third embodiment. Like the first embodiment, the present embodiment may be constructed so that the first mirror M1 has a floating electric potential.

### Sixth Embodiment

A Fabry-Perot interferometer 100 of a sixth embodiment will be described below. FIG. 17 is a sectional view illustrating a schematic configuration of the Fabry-Perot interferometer 100 of the sixth embodiment. In FIG. 17, although the first mirror M1 is illustrated thicker than the second mirror M2, actual thicknesses of the first and second mirrors M1, M2 are not limited to the thickness difference in FIG. 17. The thickness difference in FIG. 17 merely shows that, as compared to the first electrode 35, the first mirror M1 is more projected toward the second mirror structure 70, and the relation dei>dmi is satisfied. Among the first and second mirror structure 30, 70, FIG. 17 illustrates only parts opposed to each other via the air gap “AG”.

The Fabry-Perot interferometer 100 of the sixth embodiment can have the basically same structure as those of the above-described embodiments. A difference from the above-described embodiments includes the followings. As shown in FIG. 17, the projection part 42 is provided in the first mirror structure 30. The first mirror M1 is provided in the projection part 42. The first electrode 35 is provided in the first mirror structure 30 so that the first electrode 35 is located not in the projection part 42.

In the example shown in FIG. 17, the first mirror M1 and the first electrode 35 are electrically separated from each other by the insulating separation region 36 in the first mirror structure 30. In the second mirror structure 70, the second mirror M2 and the second electrode 75 are electrically connected with each other. The second mirror M2 is included in the second-electrode-inclusive-portion E2, which is electrically connected with and is inclusive of the second electrode 75. Because the insulating separation region 36 is provided in the mirror structure including the projection part 42, it is unnecessary to take into consideration a distance (corresponding to the distance “de2” in FIG. 1) between the projection part 42 and the portion E2. Therefore, designing the Fabry-Perot interferometer 100 can be facilitated for the same reason given in the second embodiment. Moreover, it is possible to reduce width of the insulating separation region 36 in the perpendicular direction, and thus, it is possible to reduce the size of the Fabry-Perot interferometer 100.

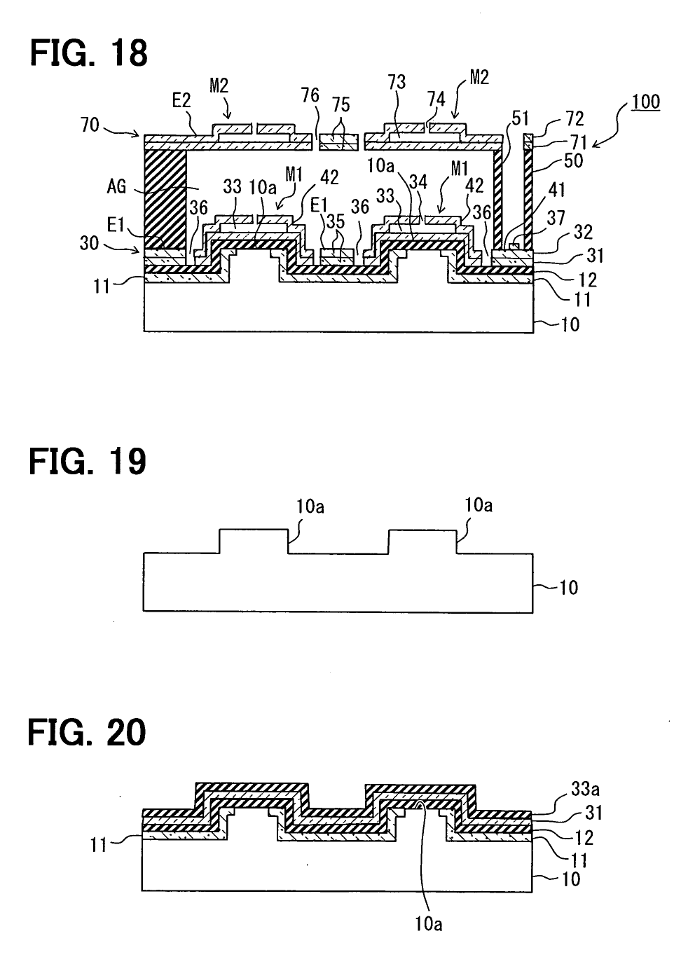

An example structure of the Fabry-Perot interferometer 100 will be more specifically described below. FIG. 18 is a sectional view that specifically illustrates the Fabry-Perot interferometer 100 in FIG. 17. Like the structure in the fifth embodiment, the structure illustrated in FIG. 18 includes the followings. At least a part of the electrode 35, 75 is provided in the center region of each mirror structure 30, 70. The mirror M1, M2 is provided in the periphery region surrounding the center region. A difference between the present embodiment and the fifth embodiment includes the following. In the present embodiment, the projection part 42 is provided in the first mirror structure 30. The blow explanation focuses on this difference.

In the case of the Fabry-Perot interferometer 100 in FIG. 18 also, a planar rectangular semiconductor substrate made of single crystal silicon is used as one example of the substrate 10. A convex region 10a is formed on one surface of the substrate 10 to correspond the formation region of the projection part 42 with the first mirror M1. Although not shown in the drawings, the convex region 10a has a substantially planar “C” shape surrounding a center part of the first electrode M1, like the first mirror formation region M1a of the fifth embodiment has.

An absorption part 11 doped with impurities is selectively disposed in a surface layer of the one surface the substrate 10 having the convex region 10a, so that the absorption part 11 is selectively disposed in the surface layer except the region for spectroscopy. In the above, the region for spectroscopy is located below the first mirror M1. The insulating film 12 is formed above the one surface of the substrate 10. The insulating film 12 acts as an etching stopper in the formation of the insulating separation region 36. The first mirror structure is 30 arranged above the one surface of the substrate 10 through the insulating film 12.

The first mirror structure 30 of the present embodiment has the substantially same structure as that of the fifth embodiment. In the first mirror structure 30 with a planar rectangular shape, at least a part of the first electrode 35 is formed in the center region having a planar circular shape, and the first mirror M1 is formed in the periphery region surrounding the center region. In the above, the first electrode 35 is formed by implanting impurities into the large refractive index layers 31, 32.

In the present embodiment, the air layer 33 acting as the small refractive index layer is interposed between the large refractive index lower layer 31 and the large refractive index upper layer 32 above the convex region 10a of the substrate 10. Thereby, the first mirror M1 having an optical multilayered film structure is provided. In the first mirror structure 30, the projection part 42 including the first mirror M1 is located above the convex region 10a and projected toward the second mirror structure 70. Although not shown in the drawings, the projection part 42 including the first mirror M1 has a substantially planar “C” shape so as correspond to the convex region 10a.

Via a connection part (not shown, cf. the connection part 40 in FIG. 16), the center region having a part of the first electrode 35 is connected with the outermost part 41 located outward of the first mirror M1. A pad 37 for the first electrode 35 is formed on a surface of the large refractive index upper layer 32 of the outermost part 41. More specifically, the connection part is disposed between ends of the “C” shaped part of the projection part 42 having the first mirror M1. In the parts (i.e., the connection part and the outermost part 41) for electrically connecting the first electrode 35 to the pad 37, the large refractive index layers 31, 32 are in contact with each other and have implanted impurities like the part of the first electrode 35 in the center region has. That is, the center region, the connection part and the outermost part 41 act as the first electrode 35.

The trench (void) acting as the insulating separation region 36 electrically mechanically separates the center region, the connection part and the outermost part 41, in each of which the first electrode 35 is formed, from the region in which the first electrode is formed. That is, the first mirror M1 and the first electrode 35 are electrically insulated and separated from each other.

The second mirror structure 70 disposed above the first mirror structure 30 via the support 50 has the substantially same structure as that in the fifth the embodiment, except that the projection part 78 is not provided in the second mirror structure 70. More specifically, the second electrode 75 is formed in the second mirror structure 70 by implanting impurities into the large refractive index layers 71, 72 in at least the center region of the second mirror structure 70. The second mirror M2 is formed in the periphery region surrounding the center region. The second mirror M2 is formed to correspond to the first mirror M1, and is an air mirror with an optical multilayered film structure, in which the air layer 73 acting as the small refractive index layer is interposed between the large refractive index lower layer 71 and the large refractive index upper layer 72.

The second mirror M2 is formed in a second mirror formation region with a substantially planar C shape so as to correspond to the first mirror M1. In a manner similar to the above-described connection part 40, the second electrode 75 is electrically coupled with a corresponding pad 77 via a connection part disposed between ends of the C shaped second mirror formation region.

In the Fabry-Perot interferometer 100 of the present embodiment also, a part of the first electrode 35 and a part of the second electrode 75 are respectively formed in the center regions, which are located distant from the support 50 as compared to the periphery regions. In other words, the second electrode 75 is formed at a center part of the membrane “MEM”. In the above, the center part is easily flexible among the membrane “MEM”. Accordingly, a spring constant of the membrane “MEM” of the second mirror structure 70 is smaller than that of the first embodiment. The voltage to be applied for changing the air gap “AG” to a desired size can be reduced, compared to the structure illustrated in the first embodiment.

One example manufacturing method of the Fabry-Perot interferometer 100 will be described below. FIGS. 19 to 24 are sectional views illustrating a manufacturing method of the Fabry-Perot interferometer 100 shown in FIG. 18. Steps of the manufacturing method may be successive in the order from the FIG. 19.

First, as shown in FIG. 19, a semiconductor substrate made of single crystal silicon is prepared as the substrate 10. One surface of the substrate 10 is patterned, and thereby, the convex region 10a is formed at a part where the projection part 42 (the first mirror M1) of the first mirror structure 30 is to be formed.

After the formation of the convex region 10a, an absorption part 11 is formed in a surface layer of the one surface of the substrate 10 by incorporating impurities such as boron (B) and the like in the surface layer except a region for spectroscopy of the first mirror M1 and the second mirror M2, as shown in FIG. 20. Then, an insulating film 12 such as a silicon nitride film and the like is uniformly deposited and formed above the whole one surface of the substrate 10. A large refractive index layer 31 and a small refractive index layer 33a are deposited and formed on the insulating film 12 in this order. In the above, the large refractive index layer 31 may be a polysilicon film or the like, and the small refractive index layer 33a may be a silicon oxide film or the like.

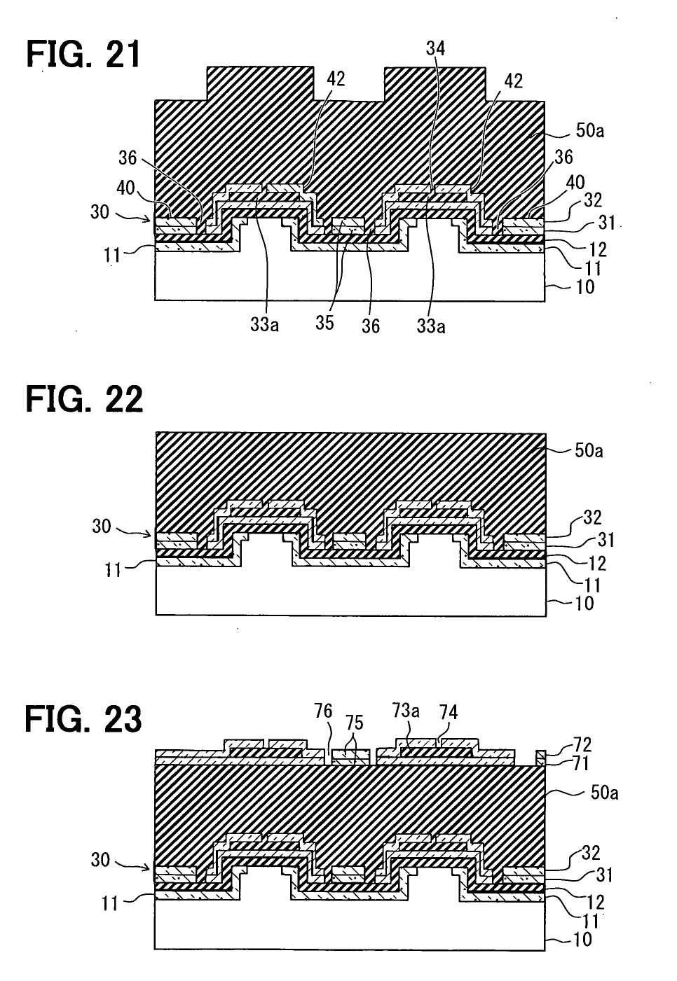

Then, a mask (not shown) including a resist or the like is formed on a surface of the small refractive index layer 33a. Etching the small refractive index layer 33a through the mask is performed by, for example, anisotropic dry etching such as RIE and the like, and thereby the small refractive index layer 33a is patterned, as shown in FIG. 21. It should be noted that at a later process, the patterned small refractive index layer 33a will be etched and changed into an air layer 33 of the first mirror M1. The mask is removed, and a large refractive index layer upper layer 32 made of polysilicon or the like is formed above the large refractive index lower layer 31 so as to cover the small refractive index layer 33a.

Then, a mask (not shown) is formed on a surface of the large refractive index upper layer 32. Through the mask, the large refractive index layers 31 and 32 are etched by, for example, anisotropic dry etching such as RIE and the like, and thereby a trench acting as an insulating separation region 36 is formed at a predetermined position so that the trench penetrates through the large refractive index layers 31 and 32. Further, a through hole 34 reaching the small refractive index layer 33a is formed at a part of the large refractive index layer 32 above the small refractive index layer 33a. Then, after the mask is removed, another mask is newly formed on a surface of the large refractive index upper layer 32. Through the mask, impurities are implanted into the large refractive index layers 31, 32 by ion implantation. By the ion implantation, a first electrode 35 (and a connection part, and an outermost part 41 and the like) are formed.

In the above formation of the first mirror structure 30, after the first electrode 35 is formed, the trench acting as the insulating separation region 36 may be formed by etching the large refractive index layers 31, 32.

Then, the mask is removed, and a sacrifice layer 50a such as a silicon oxide film and the like is deposited and formed on the whole of a surface of the large refractive index upper layer 32. In the above formation of the sacrifice layer 50a, the sacrifice layer 50a is also disposed in the through hole 34 and the trench acting as the insulating separation region 36. In the above, because of the presence of the convex region 10a of the substrate 10, a surface of the sacrifice layer 50a becomes concaved and convexed, as shown in FIG. 21. A material of the sacrifice layer 50a is not limited to a particular material as long as the sacrifice layer 50a is made of an electrical insulating material. It may be however preferable that a material of the sacrifice layer 50a and that of the small refractive index layer 33a be the same. Then, as shown in FIG. 22, the surface of the sacrifice layer 50a is polished and planarized by chemical mechanical polishing (CMP) or the like. This process causes the distance “dei” between the portion E1 and the portion E2 to be finally longer than the distance “dmi” between the mirrors.

After the sacrifice layer 50a is planarized, the large refractive index lower layer 71 made of polysilicon or the like is deposited and formed on the whole surface of the sacrifice layer 50a, as shown in FIG. 23. Then, the small refractive index layer 73a such as the silicon oxide film and the like is deposited and formed. Then, a mask (not shown), which may include a resist or the like, is formed on a surface of the small refractive index layer 73a. Through the mask, the small refractive index layer 73a is etched so that a portion of the small refractive index layer 73a for the second mirror M2 selectively remains. Then, after the mask is removed, a large refractive index upper layer 72 is deposited and formed above the large refractive index lower layer 71 so as to cover the patterned small refractive index layer 73a.

Then, another mask is newly formed on a surface of the large refractive index upper layer 72. Through the mask, impurities are implanted into the large refractive index layers 71, 72 by ion implantation. By the ion implantation, a second electrode 75, and the connection part etc. are formed.

After the ion-implantation, a rear surface of the substrate 10 opposite to the one surface may be grinded and polished on an as-needed basis. After the mask is removed, another mask is newly formed on a surface of the large refractive index upper layer 72. The large refractive index layers 71, 72 are selectively removed by etching. Thereby, a through hole 76 penetrating through the large refractive index layers 71, 72 is formed. Further, a through hole 74 reaching the small refractive index layer 73a is formed at a part of the large refractive index upper layer 72 above the small refractive index layer 73a.

Then, as shown in FIG. 24, a part of the sacrifice layer 50a, at which the air gap AG is to be formed, is etched through the through hole 76 thereby to form the air gap “AG”. In the above, the sacrifice layer 50a filling the insulating separation region 36 is also removed with the insulating film 12 acting as the etching stopper, so that the insulating separation region 36 becomes a trench (i.e., void) communicating with the air gap AG. Further, through the through holes 34 and 74, the small refractive index layers 33a and 73a are etched, and the air layer 33, 73 are formed. In one embodiment, the above etching processes may be performed at the same step by gas-phase or vapor-phase etching using hydrofluoric acid. Accordingly, the air gap AG as well as the support 50 is formed. Further, the air layers 33, 73 as well as the mirrors M1, M2 are formed. Then, through formation of the opening 51 and the pads 37, 77 and the like, the Fabry-Perot interferometer 100 illustrated in FIG. 18 is made.

As described above, the manufacturing method of the present embodiment includes: forming a convex region 10a on one surface of the substrate 10; forming a first mirror M1 of the first mirror structure 30 above the convex region 10a as well as forming a first electrode 35 at a periphery of the convex region 10a on the one surface of the substrate 10; planarizing a surface of the sacrifice layer 50a that has a surface shape originating from concavity and convexity of the one surface of the substrate 10; and forming a second mirror structure 70 after the planarizing. Therefore, the manufacturing processes of the present embodiment may be complicated compared to those of the first embodiment in which the projection part 78 is disposed in the second mirror structure 70. Conversely, the Fabry-Perot interferometer 100 including the second mirror structure 70 with the projection part 78 may relatively simplify manufacturing processes.

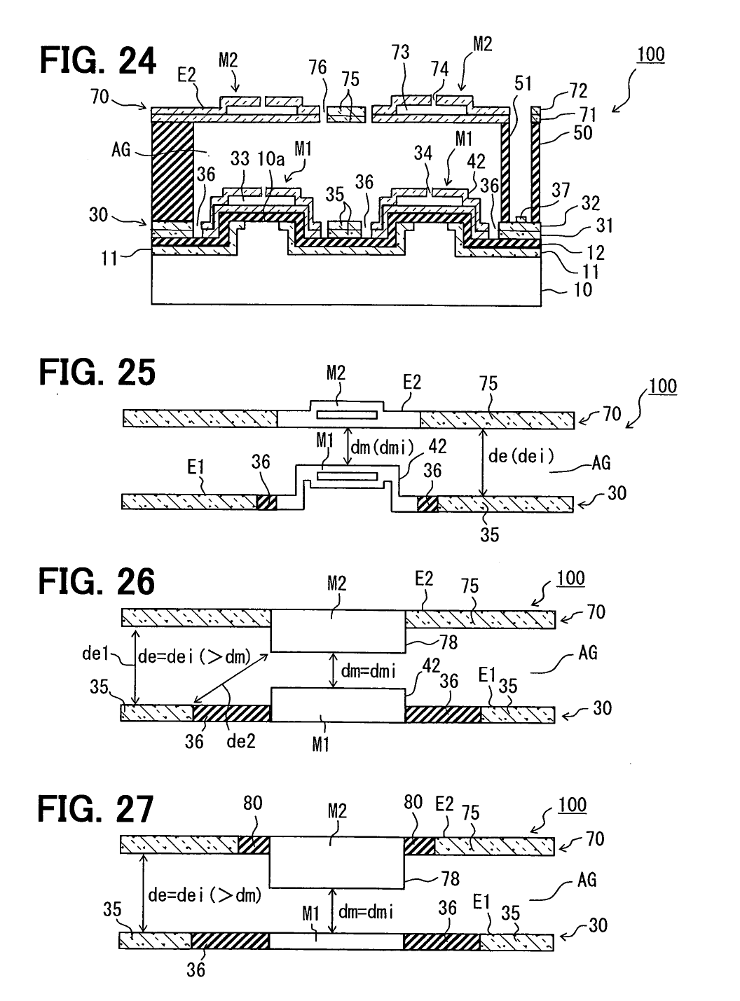

In the above example, at least a part of each electrode 35, 75 is formed in the center region. Alternatively, the above example may be modified in the following way. As shown in FIG. 25, the mirrors M1, M2 may be formed in the center regions and the electrodes 35, 75 may be formed in the periphery regions surrounding the center regions like the first embodiment. FIG. 25 is a sectional view illustrating the above modification example.

The present embodiment can be applied to or combined with the modification example of the first embodiment, the second embodiment, the third embodiment or the fourth embodiment.

The above embodiments can be modified in various ways, examples of which will be described below.

In the above embodiments, the substrate 10 is exemplified as the semiconductor substrate having the absorption part 11 at a surface layer of one surface thereof and the insulating film 12 located on the one surface. However, the substrate 10 is not limited to the above example. For example, an insulating substrate made of glass or the like may be employed as the substrate 10. In this case, the insulating film 12 is omissible.

The absorption part 11 may be such one that is formed on a surface of the substrate 10 by vapor deposition or the like. For example, the absorption part 11 may be formed on an opposite side of the substrate 10 from the first mirror structure 30 or the like.

In the above embodiments, each of the first mirror M1 and the second mirror M2 has, as an example structure, an optical multilayered film structure in which an air layer acting as the small refractive index layer is arranged between the large refractive index layers. However, a structure of the mirror is not limited to the above example. For example, a solid layer such as a silicon oxide film and the like, a liquid layer, a gas layer including gas other than air, a sol layer, a gel layer, a vacuum layer and the like may be employed as the small refractive index layer in place of the air layer 33, 73.

In the examples shown in the above embodiments, the first and second mirror structures 30, 70 are constructed so that: the projection part 42 is disposed in only the first mirror structure 30; or the projection part 78 is disposed in only the second mirror structure 70. Alternatively, as shown in FIG. 26 for example, the projection parts 42, 78 may be respectively disposed in both of the first and second mirror structures 30, 70. According to this alternative structure, it is possible to further reduce the distance “dmi” between the first and second mirrors M1, M2 in the initial state. FIG. 26 is a sectional view illustrating the above modification structure. Although the insulating separation region 36 is disposed in the first mirror structure 30 in the example shown in FIG. 26, the insulating separation region 80 may be alternatively disposed in the second mirror structure 70 in place of the insulating separation region 36.

In the above embodiments, the first and second mirror structures 30, 70 are constructed so that: the insulating separation region 36 is disposed in only the first mirror structure 30; or the insulating separation region 80 is disposed in only the second mirror structure 70. Alternatively, as shown in FIG. 27 for example, the insulating separation regions 36, 80 may be respectively disposed in the both of the first and second mirror structures 30, 70. FIG. 27 is a sectional view illustrating this modification structure. In FIG. 27, although the projection part 78 is disposed in the second mirror structure 70, the projection part 42 may be disposed in the first mirror structure 30. Further, in the above structure, when the extension part and the pad shown in FIG. 14 for each of the first and second mirrors M1, M2 is disposed, it is possible to allow the first and second mirrors M1, M2 to have the same electric potential via the pads. In this case, since the electrostatic force does not act between the mirrors M1, M2 when the voltage is applied to the electrodes 35, 75 to displace the membrane “MEM”, it is possible to control the displacement with high accuracy.

In the above embodiments, thickness of each film of the optical multilayered film structure in first and second mirrors M1, M2 is not specified in detail. When the thicknesses of the large refractive index layers 31, 32, 71, 72 and the small refractive index layers 33, 73 are set to, in optical length, approximately one-fourth of a predetermined detection target wavelength, it is possible to reduce FWHM of absorbing spectrum, and consequently, it is possible to improve detection accuracy.

According to a first aspect of the disclosure, there is provided a Fabry-Perot interferometer having a first exemplary configuration. The Fabry-Perot interferometer includes a first mirror structure and a second mirror structure arranged opposed to each other with a gap therebetween. The first mirror structure includes a first mirror and a first electrode. The second mirror structure includes a second mirror opposed to the first mirror via the gap and a second electrode opposed to the first electrode via the gap. The gap is changeable due to an electrostatic force that is generated based on voltage application between the first electrode and the second electrode. The gap has an inter-mirror distance “dm” between the first mirror and the second mirror. The first mirror and the second mirror selectively transmit light with wavelengths determined by the inter-mirror distance “dm”. The first mirror structure and the second mirror structure have at least one of: a first configuration in which the first mirror and the first electrode are electrically insulated and separated from each other; and a second configuration in which the second mirror and the second electrode are electrically insulated and separated from each other. The first mirror structure has a first-electrode-inclusive-portion that is electrically connected with the first electrode and that is inclusive of the first electrode. The second mirror structure has a second-electrode-inclusive-portion that is electrically connected with the second electrode and that is inclusive of the second electrode. The gap further has an inter-electrode-inclusive-portion-distance “de” between the first-electrode-inclusive-portion and the second-electrode-inclusive-portion. The first mirror structure and the second mirror structure are constructed so that the inter-electrode-inclusive-portion-distance “dei” is larger than the inter-mirror distance “dmi”, where the inter-mirror distance “dmi” and the inter-electrode-inclusive-portion-distance “dei” are respectively the inter-mirror distance “dm” and the inter-electrode-inclusive-portion-distance “de” in a state of an absence of the voltage application between the first electrode and the second electrode.

According the above Fabry-Perot interferometer, the first mirror and the first electrode are electrically insulated and separated from each other, and/or, the second mirror and the second electrode are electrically insulated and separated from each other. Thus, when the voltage is applied between the first electrode and the second electrode to change the gap, the first mirror and the first electrode does not have the same electric potential, and/or, the second mirror and the second electrode does not have the same electric potential. The electrostatic force is not generated between the first mirror and the second mirror substantially or at all. Therefore, a pull-in limit depends on not the inter-mirror distance “dm” but the inter-electrode-inclusive-portion-distance “de”. In the above, the first-electrode-inclusive-portion can be a portion having the same electric potential as the first electrode, and the second-electrode-inclusive-portion can be a portion having the same electric potential as the second electrode.

According to the above Fabry-Perot interferometer, moreover, the inter-mirror distance “dmi” is larger than the inter-electrode-inclusive-portion-distance “dei” in the state of the absence of the voltage application (i.e., dei>dmi). When the inter-electrode-inclusive-portion-distance “de” is decreased from “dei” by “⅓ dei”, the first-electrode-inclusive-portion and the second electrode-inclusive-portion are punt into a pull-in limit. The inter-electrode-inclusive-portion-distance “de” at the pull-in limit is denoted by “dep” and expressed as:

dep=dei×⅔. Relation (15)

The inter-mirror distance “dm” at this pull-in limit is denoted by “dmp” and written as

dmp=dmi−(dei×⅓). Relation (16)

Because the relation “dei>dmi” is satisfied as described above, the relation “dei×⅓>dmi×⅓” is satisfied. Therefore, without reaching the pull-in limit, the inter-mirror distance “dm” can be changed by more than “dmi×⅓” from the state of the absence of the voltage application. The Fabry-Perot interferometer can control the inter-mirror distance “de” in a large range without reaching a pull-in limit, and can therefore broaden a spectroscopy band as compared to a conventional Fabry-Perot interferometer.

The above Fabry-Perot interferometer may be configured to have such a second exemplary configuration that: the first mirror is projected toward the second mirror structure as compared to the first electrode; and/or the second mirror is projected toward the first mirror structure as compared to the second electrode.

According the second exemplary configuration, because the first mirror can be projected into the gap toward the second mirror structure as compared to the first electrode, or because the second mirror can be projected into the gap toward the first mirror structure as compared to the second electrode, it is possible to reduce the inter-mirror distance “dmi” compared to a structure where the first mirror and the second mirror are not projected. Thus, it is possible to make the inter-mirror distance “dmi” larger than the inter-electrode-inclusive-portion-distance “dei”.

The above Fabry-Perot interferometer may be configured to have such a third exemplary configuration that: the first mirror is electrically insulated and separated from the first electrode and is projected toward the second mirror structure as compared to the first electrode; and/or the second mirror is electrically insulated and separated from the second electrode and is projected toward the first mirror structure as compared to the second electrode.

In connection with the above Fabry-Perot interferometer having the third exemplary configuration, if a mirror projected as compared to an electrode were electrically connected with the electrode in one mirror structure, the mirror would act as an electrode in terms of electrostatic force generation, and a distance “de2” between a projection portion including the mirror of one mirror structure and an electrode-inclusive portion of the other mirror structure should be considered as the inter-electrode-inclusive portion distance in designing the Fabry-Perot interferometer. According to the Fabry-Perot interferometer having the third exemplary configuration in contrast, since the projection part including the mirror is electrically insulated and separated from the electrode in one mirror structure, it is not necessary to consider the distance “de2” in designing the Fabry-Perot interferometer. Therefore, it is possible to facilitate designing the Fabry-Perot interferometer. Moreover, it is possible to reduce width of an insulating separation region in a direction perpendicular to a displacement direction, and it is possible to reduce size of the Fabry-Perot interferometer.

The above Fabry-Perot interferometer may be configured to have such a fourth exemplary configuration that the first mirror structure and the second mirror structure satisfy

dei≧3×dmi. Relation (17)

According to the fourth exemplary configuration, as is clear from Relations (16) and (17), the first mirror and the second mirror can contact each other without an occurrence of the pull-in phenomena. It is therefore possible to further broaden a spectroscopy band. For a primary light (n=1), the wavelength λ of transmitted light can be within a range between 0 and 2×dmi.

The above Fabry-Perot interferometer may be configured to have such a fifth exemplary configuration that the first mirror structure and the second mirror structure are constructed to satisfy the following relation:

dei≧3×(1−λmin/λmax)×dmi, Relation (18)

where λmax and λmin are a maximum and a minimum of a wavelength range of the selectively-transmitted light, respectively.

According to this configuration, the light with wavelengths between λmin and λmax can be transmitted.

The above Fabry-Perot interferometer may be configured to have such a sixth exemplary configuration that the first mirror structure and the second mirror structure are constructed to satisfy

dei≧1.1×dmi. Relation (19)

According the above sixth exemplary configuration, the detection of CO2 (4.2 μm), ethanol (3.4 μm) and water vapor (2.6 μm) with the primary light (n=1) is possible by using a single Fabry-Perot interferometer. Thus, the sixth exemplary configuration can be suitable for an alcometer (e.g., alcohol breath test sensor). In the above, a parenthetical value is an infrared absorption wavelength of the material in gas phase.

Alternatively, the Fabry-Perot interferometer may be configured to have such a seventh exemplary configuration that: the first mirror structure and the second mirror structure are constructed to satisfy the following relation:

dei≧2.2×dmi. Relation (20)

According to the seventh exemplary configuration, the Fabry-Perot interferometer can further detect ethanol by further using an infrared absorption wavelength of 9.5 μm. It is therefore possible to detect CO2 (4.2 μm), ethanol (3.4 μm, 9.5 μm) and water vapor (2.6 μm) with the primary light (n=1) by using a single Fabry-Perot interferometer. In the above, a parenthetical value is an infrared absorption wavelength of the material in gas phase.

In the above Fabry-Perot interferometer, the mirror insulated and separated from the electrode may not have an electric potential fixed to a predetermined value but have a floating electric potential. Alternatively, the above Fabry-Perot interferometer may be configured to have such an eighth exemplary configuration that: the first mirror and the first electrode are electrically separated from each other, and the second mirror and the second electrode are electrically connected with each other, and the first mirror is electrically coupled with the second electrode; or the first mirror and the first electrode are electrically connected with each other, the second mirror and the second electrode are electrically separated from each other, and the second mirror is electrically coupled with the first electrode.

According to the above eight exemplary configuration, since the first mirror and the second mirror can have the same electric potential, the electrostatic force is not generated between the first mirror and the second mirror. Thus, it is possible to further broaden a spectroscopic band compared to a case where one of the first mirror and the second mirror has a floating electric potential. Moreover, since the electrostatic force is not generated between the first mirror and the second mirror, it is possible to easily control and adjust size of the gap to a desired size.

The above Fabry-Perot interferometer may be configured to have such an ninth exemplary configuration that: the first mirror structure has a first center region and a first periphery region surrounding the first center region; the second mirror structure has a second center region and a second periphery region surrounding the second center region; the first center region and the second center region are opposed to each other via the gap; the first periphery region and the second periphery region are opposed to each other via the gap; the first electrode and the second electrode are respectively arranged in the first center region and the second center region; and the first mirror and the second mirror are respectively arranged in the first periphery region and the second periphery region. Alternatively, the Fabry-Perot interferometer may be configured to have such a tenth exemplary configuration that: the first mirror structure has a first center region and a first periphery region surrounding the first center region; the second mirror structure has a second center region and a second periphery region surrounding the second center region; the first center region and the second center region are opposed to each other via the gap; the first periphery region and the second periphery region are opposed to each other via the gap; the first mirror and the second mirror are respectively arranged in the first center region and the second center region; and the first electrode and the second electrode are respectively arranged in the first periphery region and the second periphery region. The above ninth and tenth exemplary configurations may further include a support that is provided between the first mirror structure and the second mirror structure, and that surrounds the gap.

According to the ninth exemplary configuration, since the electrode is disposed in the center region distant from the support, it is possible to make a spring constant of the mirror structure (e.g., an electrode on which the electrostatic force acts) smaller than that in the second optional configuration. It is therefore possible to reduce magnitude of the voltage applied to change the gap into a certain size. According to the tenth exemplary configuration, since the mirror is disposed in the center region distant from the support, it is possible to easily keep the mirrors parallel to each other even in the state of the voltage application. It is therefore possible to reduce full width at half maximum (FWHM) of transmitted light while reducing size of the Fabry-Perot interferometer, compared to the ninth exemplary configuration.

The above Fabry-Perot interferometer may be configured to have such an eleventh exemplary configuration that: each of the first mirror structure and the second mirror structure includes a plurality of large refractive index layers each being a semiconductor thin-film containing at least one of silicon and germanium; each of the first mirror and the second mirror has an optical multilayered film structure in which a small refractive index layer is interposed between the large refractive index layers; the small refractive index layer has a refractive index smaller than each large refractive index layer; the first electrode is a part of the large refractive index layers of the first mirror structure, the part having therein dopant impurities with one of a p conductivity type and an n conductivity type; and the second electrode is a part of the large refractive index layers of the second mirror structure, the part having therein dopant impurities with one of the p conductivity type and the n conductivity type.

The semiconductor thin-film containing at least one of silicon and germanium is transmissive for an infrared light with wavelengths between 2 μm and 10 μm. Thus, the Fabry-Perot interferometer having the eleventh exemplary configuration may be suitable for a wavelength selection filter of an infrared gas detector. For example, the Fabry-Perot interferometer may be suitable for the above-described alcometer.

The above Fabry-Perot interferometer may be configured to have such a twelfth exemplary configuration that: the small refractive index layer is made of one of air and vacuum. If the small refractive index layer is made of air or vacuum, a ratio nH/nL of a refractive index nH of the large refractive index layer (e.g., nH=3.45 for Si, nH=4 for Ge) to that nL of the small large refractive index layer (e.g., nL=1 for air) can have a large value (e.g., nH/NL=3.3 or more). It is there possible to selectively transmit the infrared light with wavelengths in the above-described range.

According to a second aspect of the present disclosure, there is provided a method of manufacturing the Fabry-Perot interferometer having the second exemplary configuration. The first method includes: forming a first electrode and at least a part of a first mirror on one surface of a substrate, wherein the first electrode and the first mirror are parts of a first mirror structure; forming a sacrifice layer on the first mirror structure; forming a recession region on a surface of the sacrifice layer by pattering the sacrifice layer, so that the recession region is located on an opposite side of the sacrifice layer from the first mirror structure, wherein the recession region corresponds to a region in which a second mirror is to be formed; forming a second electrode and at least a part of the second mirror on the surface, which has the recession region, of the sacrifice layer, wherein the second electrode and the second mirror are parts of a second mirror structure; and after forming the second mirror structure, forming a gap between the first mirror structure and the second mirror structure by etching the sacrifice layer.

According to the above first exemplary method, the second mirror of the second mirror structure is formed in the recession region of the surface of the sacrifice layer. The second electrode is formed on the surface of the sacrifice layer so that the second electrode is located in a periphery of the recession region. Thereby, it is possible to provide the Fabry-Perot interferometer in which the second mirror of the second mirror structure is projected toward the first mirror structure.

According to a third of the present disclosure, there is provided another method of manufacturing the Fabry-Perot interferometer having the second exemplary configuration. The method includes: forming a convex region on one surface of a substrate by pattering the substrate, wherein the convex region corresponds a region in which a first mirror is to be formed; forming a first electrode and at least a part of the first mirror on the one surface, which has the convex region, of the substrate, wherein the first electrode and the first mirror are parts of a first mirror structure; forming a sacrifice layer on the first mirror structure; planarizing a surface of the sacrifice layer, wherein the surface to be planarized is located on an opposite side of the sacrifice layer from the first mirror structure; forming a second electrode and at least a part of a second mirror on the planarized surface of the sacrifice layer, wherein the second electrode and the second mirror are parts of a second mirror structure; and after forming the second mirror structure, forming a gap between the first mirror structure and the second mirror structure by etching the sacrifice layer.

According to the above method, the first mirror of the first mirror structure is formed on the convex region of the one surface of the substrate. The first electrode is formed on the one surface of the substrate so that the first electrode is located in a periphery of the convex region. After the surface of the sacrifice layer having a surface shape originating from irregularity of the one surface of the substrate is planarized, the second mirror structure is formed. Thereby, it is possible to provide the Fabry-Perot interferometer in which the first mirror of the first mirror structure is projected toward the second mirror structure.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

What is claimed is:

1. A Fabry-Perot interferometer comprising:
a first mirror structure and a second mirror structure arranged opposed to each other with a gap therebetween,
wherein:
the first mirror structure includes a first mirror and a first electrode;
the second mirror structure includes a second mirror opposed to the first mirror via the gap and a second electrode opposed to the first electrode via the gap;
the gap is changeable due to an electrostatic force that is generated based on voltage application between the first electrode and the second electrode;
the gap has an inter-mirror distance “dm” between the first mirror and the second mirror;
the first mirror and the second mirror selectively transmit light with wavelengths determined by the inter-mirror distance “dm”;
the first mirror structure and the second mirror structure have at least one of
a first configuration in which the first mirror and the first electrode are electrically insulated and separated from each other, and
a second configuration in which the second mirror and the second electrode are electrically insulated and separated from each other;
the first mirror structure has a first-electrode-inclusive-portion that is electrically connected with the first electrode and that is inclusive of the first electrode;
the second mirror structure has a second-electrode-inclusive-portion that is electrically connected with the second electrode and that is inclusive of the second electrode;
the gap further has an inter-electrode-inclusive-portion-distance “de” between the first-electrode-inclusive-portion and the second-electrode-inclusive-portion; and
the first mirror structure and the second mirror structure are constructed so that the inter-electrode-inclusive-portion-distance “dei” is larger than the inter-mirror distance “dmi”, where the inter-mirror distance “dmi” and the inter-electrode-inclusive-portion-distance “dei” are respectively the inter-mirror distance “dm” and the inter-electrode-inclusive-portion-distance “de” in a state of an absence of the voltage application between the first electrode and the second electrode.

2. The Fabry-Perot interferometer according to claim 1, wherein
the first mirror structure and the second mirror structure are further constructed to have one of the following configurations:
the first mirror is projected toward the second mirror structure as compared to the first electrode; and
the second mirror is projected toward the first mirror structure as compared to the second electrode.

3. The Fabry-Perot interferometer according to claim 2, wherein
the first mirror structure and the second mirror structure are further constructed to have one of the following configurations:
the first mirror is electrically insulated and separated from the first electrode, and is projected toward the second mirror structure as compared to the first electrode; and
the second mirror is electrically insulated and separated from the second electrode, and is projected toward the first mirror structure as compared to the second electrode.

4. The Fabry-Perot interferometer according to claim 1, wherein:
the first mirror structure and the second mirror structure are constructed to satisfy the following relation:
dei≧3×dmi.

5. The Fabry-Perot interferometer according to claim 1, wherein:
the first mirror structure and the second mirror structure are constructed to satisfy the following relation:
dei≧3×(1−λmin/λmax)×dmi,
where λmax and λmin are a maximum and a minimum of a wavelength range of the selectively-transmitted light, respectively.

6. The Fabry-Perot interferometer according to claim 5, wherein:
the first mirror structure and the second mirror structure are constructed to satisfy the following relation:
dei≧1.1×dmi.

7. The Fabry-Perot interferometer according to claim 5, wherein:
the first mirror structure and the second mirror structure are constructed to satisfy the following relation:
dei≧2.2×dmi.

8. The Fabry-Perot interferometer according to claim 1, wherein
the first mirror structure and the second mirror structure have one of a first electric potential configuration and a second electric potential configuration;
the first electric potential configuration is that:
the first mirror and the first electrode are electrically separated from each other;
the second mirror and the second electrode are electrically connected with each other; and
the first mirror is electrically coupled with the second electrode; and
the second electric potential configuration is that:
the first mirror and the first electrode are electrically connected with each other;
the second mirror and the second electrode are electrically separated from each other; and
the second mirror is electrically coupled with the first electrode.

9. The Fabry-Perot interferometer according to claim 1, wherein:
the first mirror structure has a first center region and a first periphery region surrounding the first center region;
the second mirror structure has a second center region and a second periphery region surrounding the second center region;
the first center region and the second center region are opposed to each other via the gap;
the first periphery region and the second periphery region are opposed to each other via the gap;
the first electrode and the second electrode are respectively arranged in the first center region and the second center region; and
the first mirror and the second mirror are respectively arranged in the first periphery region and the second periphery region.

10. The Fabry-Perot interferometer according to claim 1, wherein:
the first mirror structure has a first center region and a first periphery region surrounding the first center region;
the second mirror structure has a second center region and a second periphery region surrounding the second center region;
the first center region and the second center region are opposed to each other via the gap;
the first periphery region and the second periphery region are opposed to each other via the gap;
the first mirror and the second mirror are respectively arranged in the first center region and the second center region; and
the first electrode and the second electrode are respectively arranged in the first periphery region and the second periphery region.

11. The Fabry-Perot interferometer according to claim 1, wherein:
each of the first mirror structure and the second mirror structure includes a plurality of large refractive index layers each being a semiconductor thin-film containing at least one of silicon and germanium;
each of the first mirror and the second mirror has an optical multilayered film structure in which a small refractive index layer is interposed between the large refractive index layers;
the small refractive index layer has a refractive index smaller than each large refractive index layer;
the first electrode is a part of the large refractive index layers of the first mirror structure, the part having therein dopant impurities with one of a p conductivity type and an n conductivity type; and
the second electrode is a part of the large refractive index layers of the second mirror structure, the part having therein dopant impurities with one of the p conductivity type and the n conductivity type.

12. The Fabry-Perot interferometer according to claim 11, wherein:
the small refractive index layer is made of one of air and vacuum.

13. A method of manufacturing a Fabry-Perot interferometer of claim 2, the method comprising:
forming a first electrode and at least a part of a first mirror on one surface of a substrate, wherein the first electrode and the first mirror are parts of a first mirror structure;
forming a sacrifice layer on the first mirror structure;
forming a recession region on a surface of the sacrifice layer by pattering the sacrifice layer, so that the recession region is located on an opposite side of the sacrifice layer from the first mirror structure, wherein the recession region corresponds to a region in which a second mirror is to be formed;
forming a second electrode and at least a part of the second mirror on the surface, which has the recession region, of the sacrifice layer, wherein the second electrode and the second mirror are parts of a second mirror structure; and
after forming the second mirror structure, forming a gap between the first mirror structure and the second mirror structure by etching the sacrifice layer.

14. A method of manufacturing a Fabry-Perot interferometer of claim 2, the method comprising:
forming a convex region on one surface of a substrate by pattering the substrate, wherein the convex region corresponds a region in which a first mirror is to be formed;
forming a first electrode and at least a part of the first mirror on the one surface, which has the convex region, of the substrate, wherein the first electrode and the first mirror are parts of a first mirror structure;
forming a sacrifice layer on the first mirror structure;
planarizing a surface of the sacrifice layer, wherein the surface to be planarized is located on an opposite side of the sacrifice layer from the first mirror structure;
forming a second electrode and at least a part of a second mirror on the planarized surface of the sacrifice layer, wherein the second electrode and the second mirror are parts of a second mirror structure; and
after forming the second mirror structure, forming a gap between the first mirror structure and the second mirror structure by etching the sacrifice layer.
